(19) United States
(12) Patent Application Publication
(10) Pub. No.: US 2023/0221993 A1
(43) Pub. Date: Jul. 13, 2023

(54) METHODS AND SYSTEMS THAT PLACE AND MANAGE WORKLOADS ACROSS HETEROGENEOUS HOSTS WITHIN DISTRIBUTED COMPUTER SYSTEMS

(71) Applicant: VMware, Inc., Palo Alto, CA (US)

(72) Inventors: Jin He, Beijing (CN); Bing Niu, Beijing (CN); Qi Liu, Beijing (CN); Junfeng Wang, Beijing (CN); Li He, Beijing (CN); Xiangjun Song, Beijing (CN)

(73) Assignee: VMware, Inc., Palo Alto, CA (US)

(21) Appl. No.: 17/678,327

(22) Filed: Feb. 23, 2022

(30) Foreign Application Priority Data
Jan. 13, 2022 (WO) PCT/CN2022/071756

(51) Int. Cl. G06F 9/50

(52) U.S. Cl. CPC G06F 9/5027

(57) ABSTRACT

The current document is directed to methods and systems that place and manage workloads across heterogeneous hosts within distributed computer systems. In a disclosed method, the functionality of an existing distributed-computer-management system designed for managing homogeneous hosts is modified and improved for application to distributed-computer systems that include heterogeneous hosts. Much of the functionality needed for managing heterogeneous hosts is obtained by modifying implementation of managed objects employed by host agents without affecting the interface between the distributed-computer-management system and the host agents. In addition, host-selection functionality within the distributed-computer-management system can be extended and improved to consider heterogeneous-host characteristics both for placing workloads across heterogeneous hosts and for live migration of virtual machines among different types of hosts.

### TECHNICAL FIELD

The current document is directed to distributed computer systems and distributed-computer-system management and, in particular, to methods and systems that place and manage workloads across heterogeneous hosts within distributed computer systems.

### BACKGROUND

During the past seven decades, electronic computing has evolved from primitive, vacuum-tube-based computer systems, initially developed during the 1940s, to modern electronic computing systems in which large numbers of multiprocessor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. However, despite all of these advances, the rapid increase in the size and complexity of computing systems has been accompanied by numerous scaling issues and technical challenges, including technical challenges associated with communications overheads encountered in parallelizing computational tasks among multiple processors, component failures, and distributed-system management. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems has, in turn, become increasingly complex, involving greater computational overheads and significant inefficiencies and deficiencies. In fact, many desired management-and-administration functionalities are becoming sufficiently complex to render traditional approaches to the design and implementation of automated management and administration systems impractical, from a time and cost standpoint, and even from a feasibility standpoint. Therefore, designers and developers of various types of automated management and control systems related to distributed computing systems are seeking alternative design-and-implementation methodologies.

### SUMMARY

The current document is directed to methods and systems that place and manage workloads across heterogeneous hosts within distributed computer systems. In a disclosed method, the functionality of an existing distributed-computer-management system designed for managing homogeneous hosts is modified and improved for application to distributed-computer systems that include heterogeneous hosts. Much of the functionality needed for managing heterogeneous hosts is obtained by modifying implementation of managed objects employed by host agents without affecting the interface between the distributed-computer-management system and the host agents. In addition, host-selection functionality within the distributed-computer-management system can be extended and improved to consider heterogeneous-host characteristics both for placing workloads across heterogeneous hosts and for live migration of virtual machines among different types of hosts.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIGS. 11A-D illustrates the problem domain addressed by the currently disclosed methods and systems.

FIGS. 12A-B illustrate a hypothetical computer system.

FIG. 13 illustrates an instruction-set architecture (“ISA”) provided by an example processor.

FIG. 14 illustrates an additional abstraction of processor features and resources used by virtual-machine monitors, operating systems, and other privileged control programs.

FIG. 15 illustrates an example multi-core processor.

FIG. 16 illustrates the components of an example processor core.

FIG. 17 illustrates the storage stack within a computer system.

FIG. 18 illustrates some of the characteristics and parameters for each of the main layers of a host that may differ between heterogeneous hosts and that may factor into placement-motivated and migration-motivated host-selection decisions.

FIG. 19 shows components of one currently available VMware management system that manages a distributed computer system.

FIG. 20 shows communications between management-system components.

FIG. 21A illustrates the managed-object-based interfaces between the management server and an HH.

FIG. 21B illustrates extending management-server management to heterogeneous hosts (“HGHs”)

FIG. 22A-E provides additional details about one implementation of the HIGH agent discussed above with reference to FIG. 21B.

FIG. 23 illustrates the host-selection process carried out by a management system for a heterogeneous distributed computer system during workload-placement and virtual-machine-migration operations.

FIG. 24 illustrates several data structures used in a description of a routine “select host” with reference to FIGS. 25-29.

FIGS. 25-29 provide control-flow diagrams for a routine “select host” that implements host-selection logic for a management system and for the routines “find host” and “eval host” that are called to implement the routine “select host.”

FIG. 30 provides a control-flow diagram for a routine “wait-queue monitor.”

### DETAILED DESCRIPTION

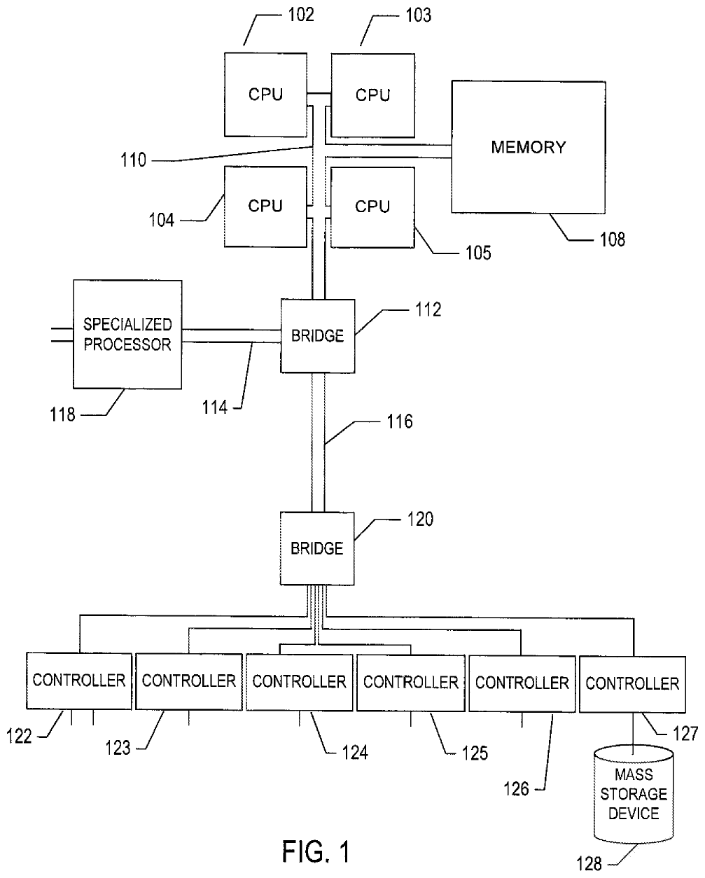

The current document is directed to methods and systems that place and manage workloads across heterogeneous hosts within distributed computer systems. In a first subsection, below, a detailed description of computer hardware, complex computational systems, and virtualization is provided with reference to FIGS. 1-10. The currently disclosed methods and systems are discussed in a second subsection.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modem science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers. network nodes, tablet computers, and mobile telephones.

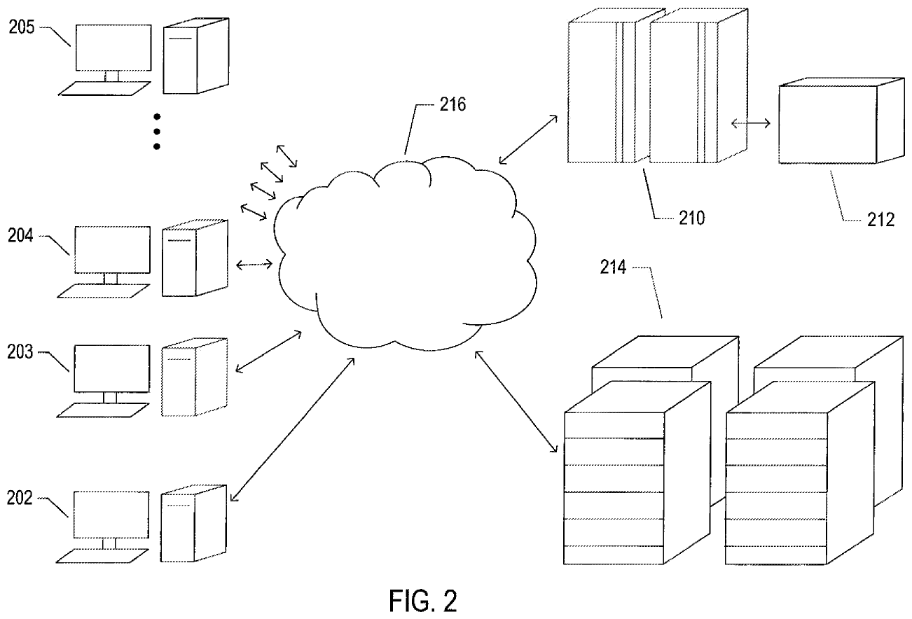

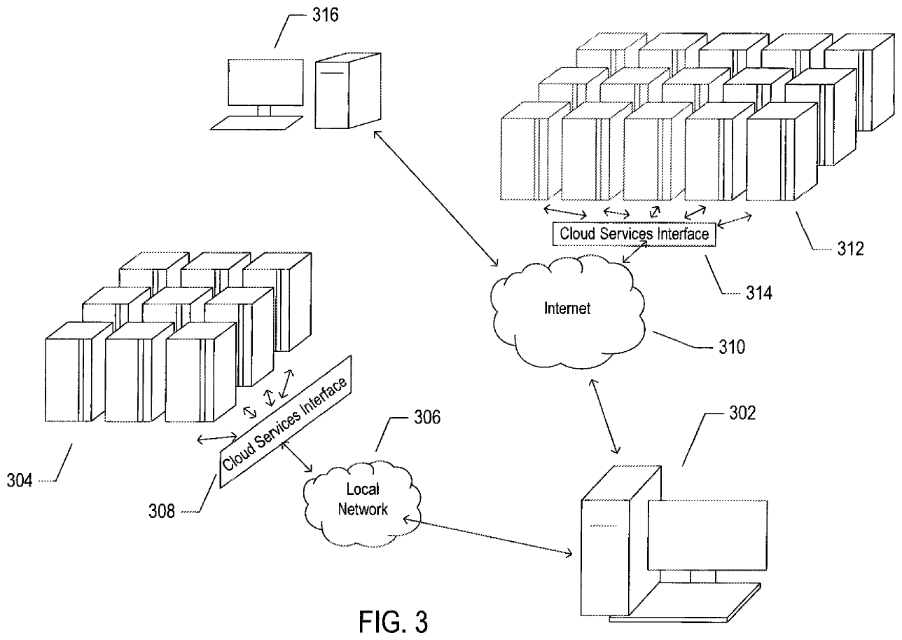

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

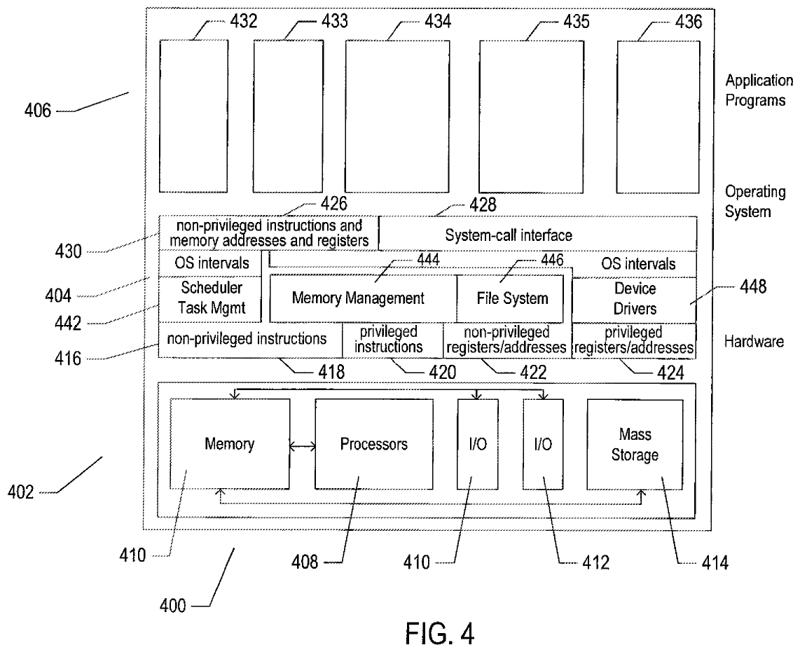

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

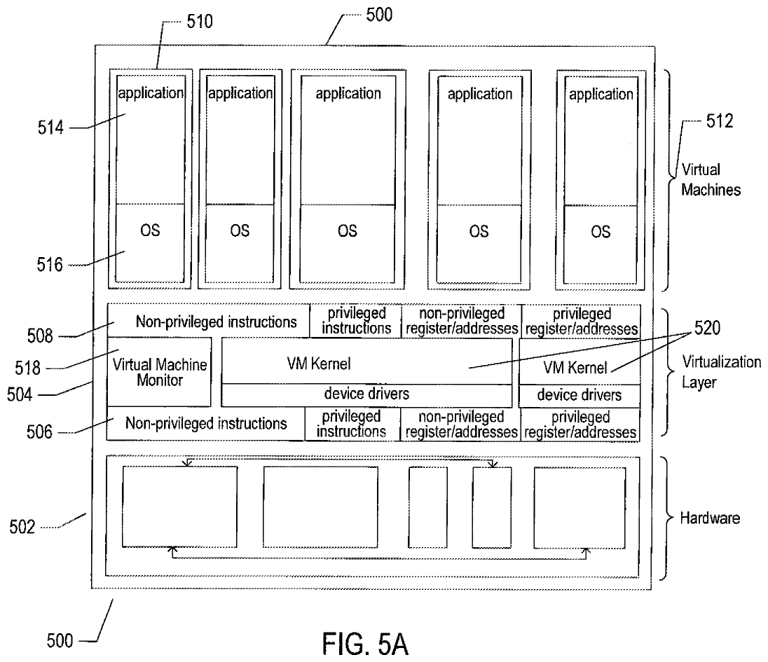

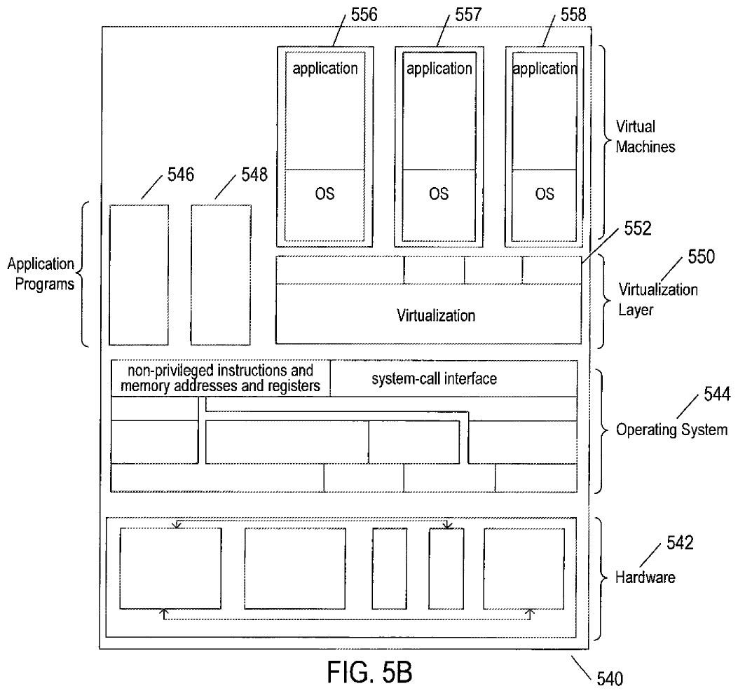

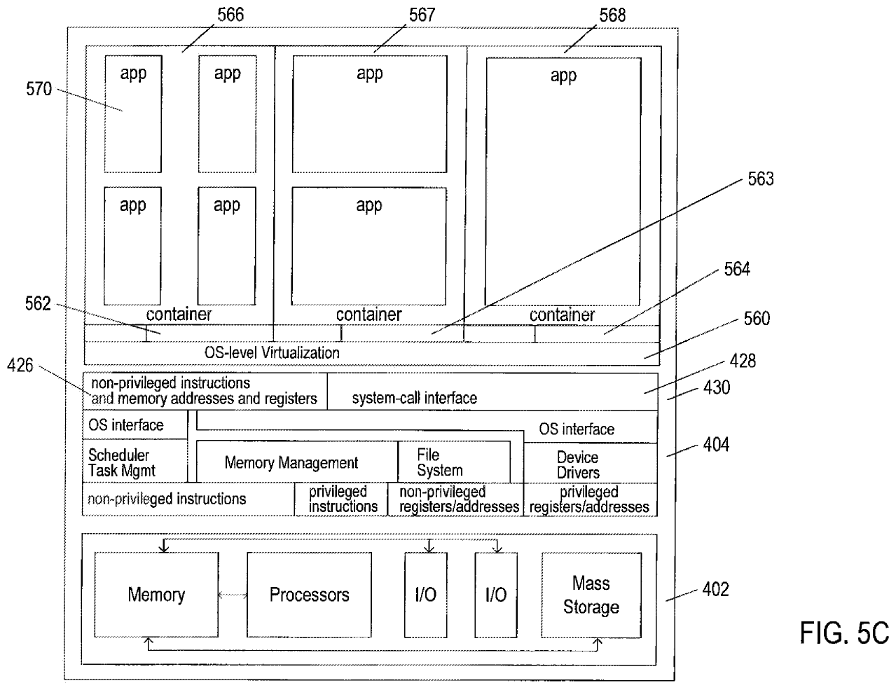

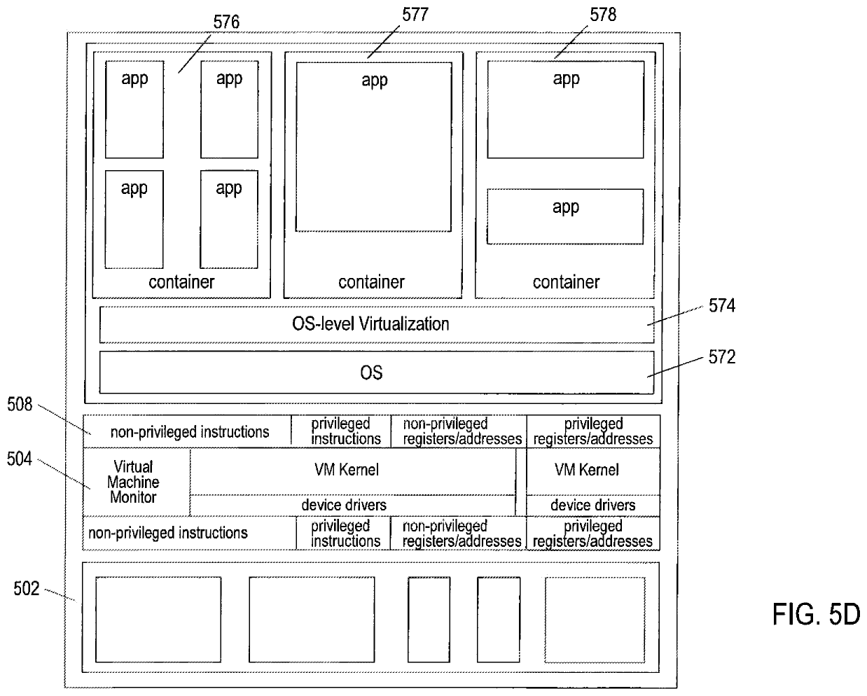

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous, distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example. OSL virtualization provides a file system to each container, but the file system provided to the container is essentially a view of a partition of the general file system provided by the underlying operating system. In essence, OSL virtualization uses operating-system features, such as namespace support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however. OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization er provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

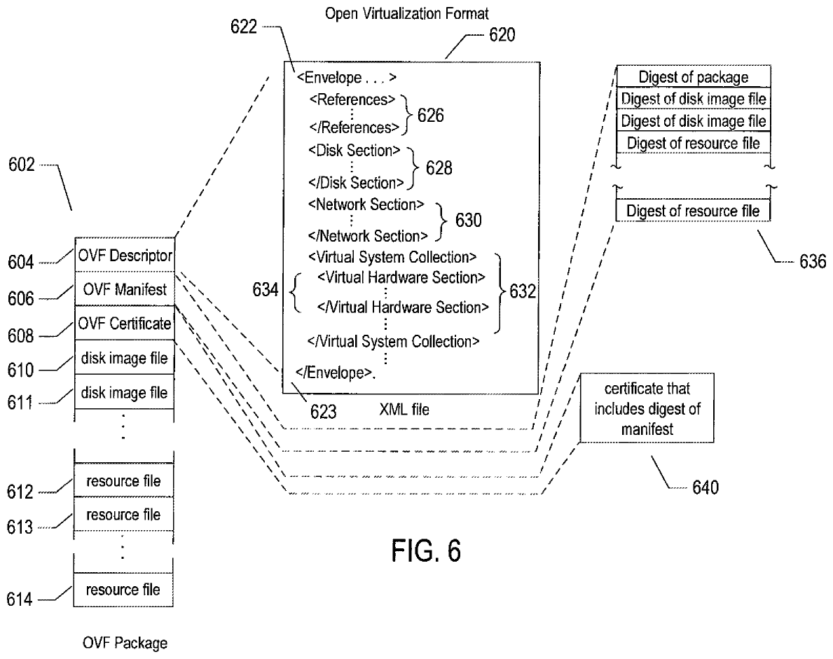

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

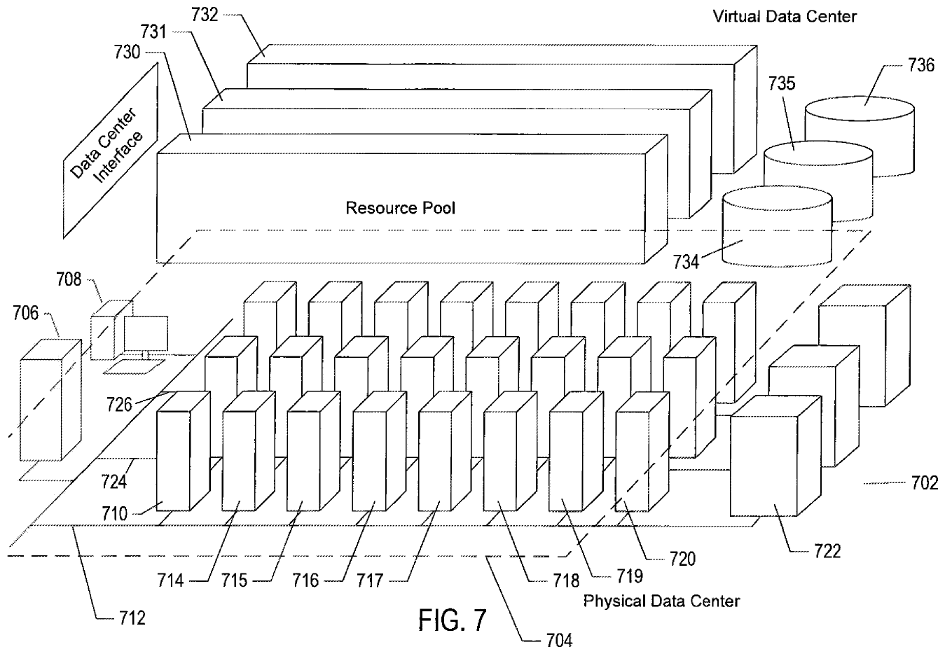

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability.

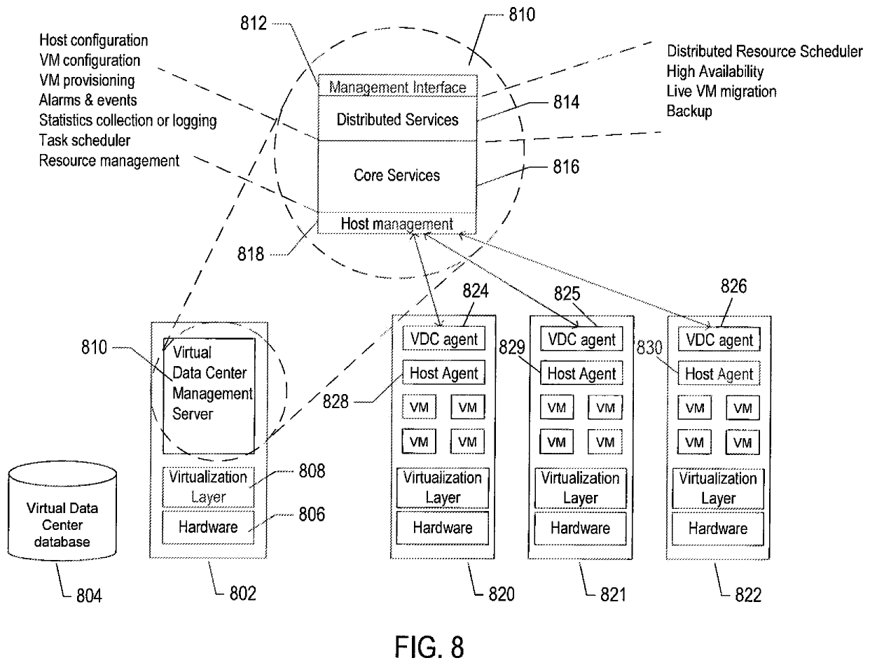

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808 and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

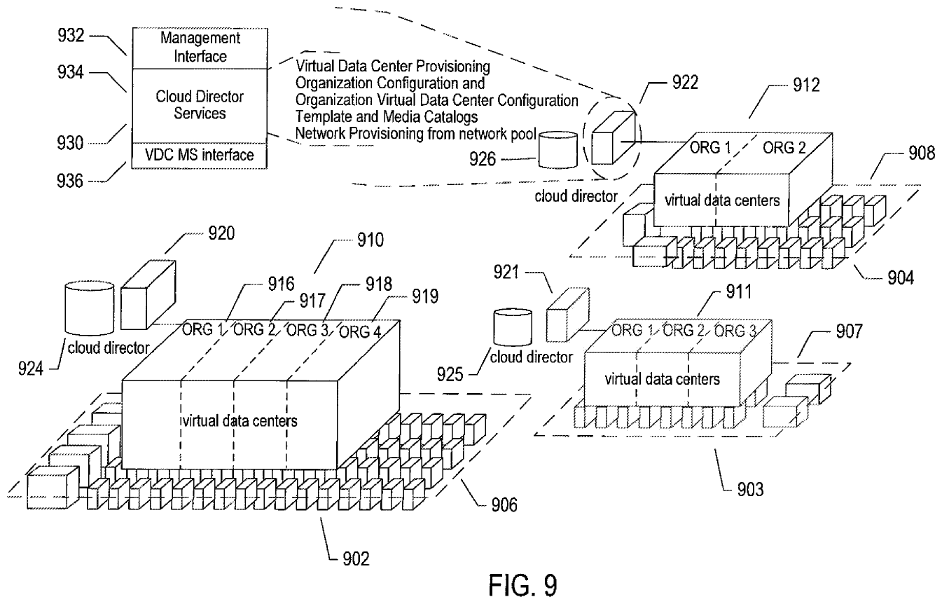

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

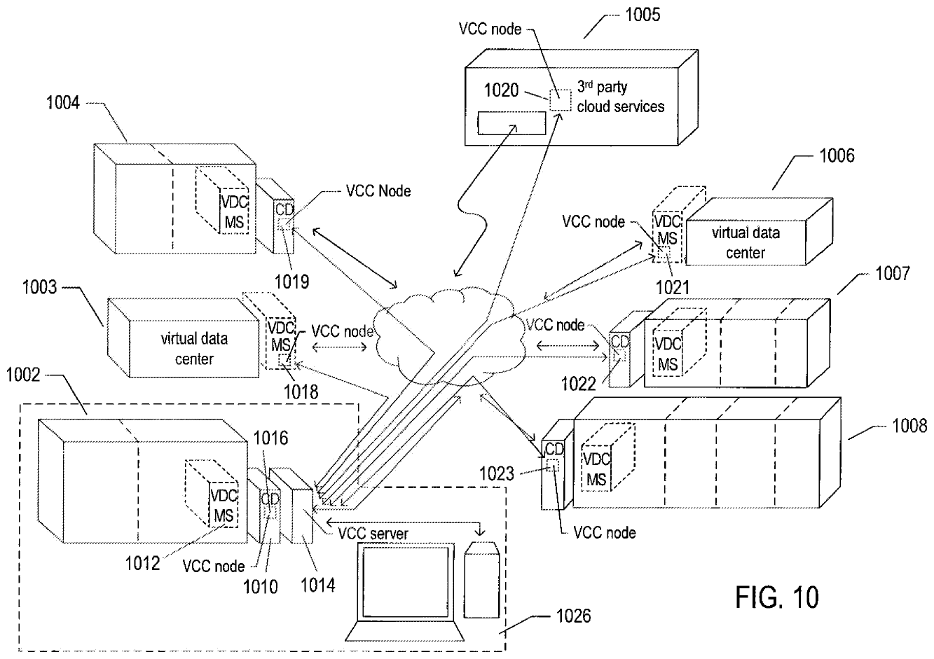

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC servers and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Currently Disclosed Methods and Systems

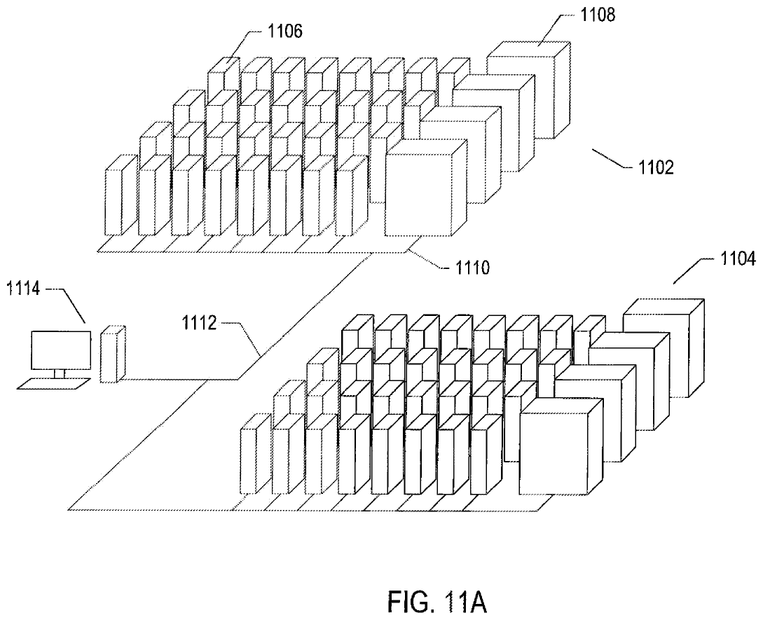

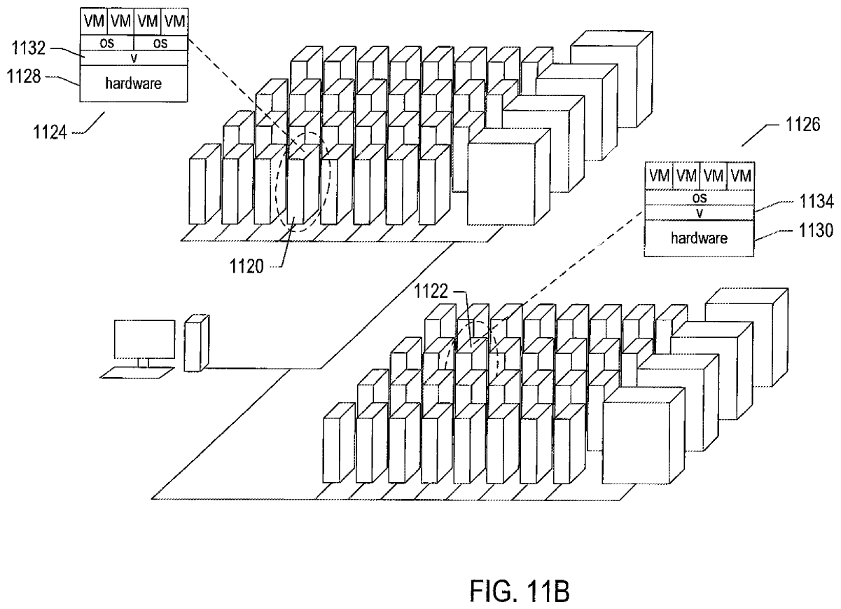

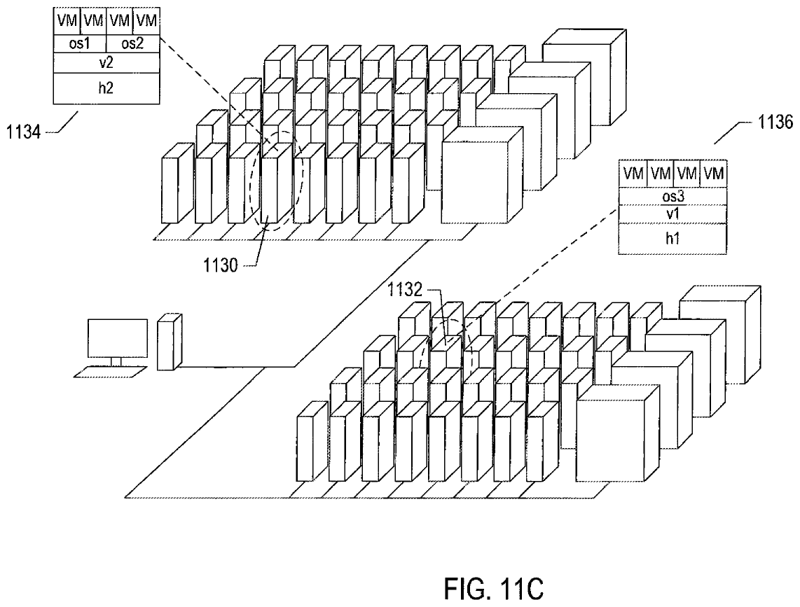

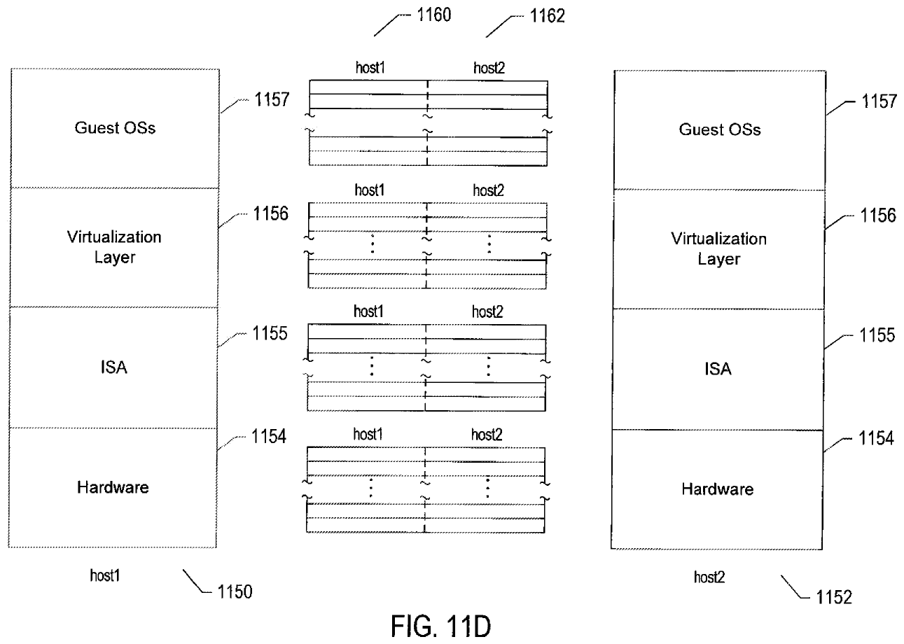

FIGS. 11A-D illustrates the problem domain addressed by the currently disclosed methods and systems. FIG. 11A illustrates an example distributed-computer-system that is managed by a management system. The example distributed computer system includes two data centers 1102 and 1104, each including multiple different server computers, or hosts, such as host 1106, as well as data-storage appliances, such as data-storage appliance 1108, and internal networks, such as internal network 1110, connected to wide-area networks, such as wide-area network 1112. The management system is generally implemented within one or more virtual machines executing on one or more host computers and by agents running within host computers, as further discussed below. The management system is accessed via a web service provided by the management system to an administrator's or manager's computer 1114. The management system provides a wide variety of management services and functionality, including services and functionalities for placing and launching virtual machines within selected host computers of the distributed computer system, for live migration of virtual machines among the hosts, for tracking virtual-machine performance and computing hosting fees, and many other services and functionalities.

As shown in FIG. 11B, the management system discussed above with reference to FIG. 11A is designed to manage a distributed-computer system of homogeneous hosts. This means that each host contains processors with a common instruction-set architecture and other hardware components and systems with common interfaces and functionalities, a common type of virtualization layer, and a common set of guest operating systems that can be included in virtual machines hosted by servers including the common type of virtualization layer. Thus, as shown in FIG. 11B, if two hosts 1120 and 1122 are randomly selected from among the hosts of the distributed computer system, and management-system functionality is used to obtain the characteristics and/or parameter values for the two hosts 1124 and 1126, respectively, the characteristics and/or parameter values would reveal that the hosts have common instruction-set architectures and other common hardware architectures 1128 and 1130, respectively, common virtualization layers 1132 and 1134, respectively, and can include a common set of guest operating systems within virtual machines that can be supported by the common virtualization layer. A particular host may have a different number of executing virtual machines than the number of executing virtual machines within another host, and the virtual machines in one host may include a different set of guest operating systems selected from the common set of guest operating systems than the set included in another host, but the hosts are sufficiently similar to allow the management system to interface to the common virtualization layer in order to manage the host computers and to both place workloads and/or virtual machines across the different host computers and live-migrate virtual machines from one host computer to another without concern for whether or not a selected host computer can support execution of the workloads and/or virtual machines at basic hardware, instruction-set-architecture, and virtualization-layer levels of functionality. The homogeneity of the hosts within a distributed computer system leads to a generally simpler implementation of the management system than would be needed for a distributed computer system including heterogeneous hosts. As shown in FIG. 11C, in a heterogeneous distributed computer system, if two hosts 1130 and 1132 are randomly selected, the corresponding characteristics and parameters 1134 and 1136 of the selected hosts may be quite different, including differences in one or more of the hardware, instruction-set-architecture, virtualization layer, and guest-operating-system layers within the hosts.

In the following discussion, a distributed computer system including homogeneous hosts is referred to as a “homogeneous distributed computer system” and a distributed computer system including heterogeneous hosts is referred to as a “heterogeneous distributed computer system.” In addition, the term “workload” refers to an application or other computational entity that is executed by one or more hosts of a distributed computer system. Workloads are generally packaged with guest operating systems in virtual machines, as discussed above in the preceding subsection of this document, which are then distributed to the virtualization layers of host computers for execution.

While it was common, for many years, for distributed computer systems to include only homogeneous hosts, primarily hosts using the Intel X860 architectures and using a particular virtualization layer supporting a standard set of different guest operating systems, it is now frequently the case that owners and administrators of distributed computer systems wish to have the flexibility to include different types of hosts within the distributed computer systems. Flexibility in choosing hosts with different virtualization layers and instruction-set architectures allows owners and administrators to support a broader range of applications that may be designed to run above different types of virtualization layers and guest operating systems and to optimize purchases of servers and other components of the distributed computer system with respect to differential pricing and availabilities. However, because many current management systems are not designed to support heterogeneous hosts, management and administration of distributed computer systems with heterogeneous hosts represents a significant and difficult-to-solve problem. While there have been attempts to develop new, more capable types of management systems that provide the desired flexibility, these attempts have fallen short of the goal of producing a full-function management system agnostic to different types of hosts, including hosts with different instruction-set architectures and virtualization layers. As traditional management systems have evolved, they have acquired many useful features and functionalities that would be difficult to redevelop for new management systems, and new types of virtualization layers and server hardware using processors with new and different instruction-set architectures continue to emerge.

FIG. 11D illustrates a comparison between two different types of hosts within a heterogeneous distributed computer system. Both a first host 1150 and a second host 1152 include the basic hardware 1154, instruction-set-architecture 1155, virtualization-layer 1156, and guest-operating-systems 1157 layers. However, in order to compare the two hosts, the characteristics and parameters for each of these layers are accumulated in tables or lists, one set of tables or lists 1160 for the first host 1150 and another set of tables or lists 1162 for the second host. Then, each of the corresponding characteristics or parameters within the aligned tables or lists are compared with one another in order to generate a set of differences for the two hosts. For management purposes, many of the differences are essentially unimportant, but certain of the differences may be critically important. For example, if the management system is attempting to find a host within a distributed computer system for hosting a particular workload, and if that workload has been developed to run on a server computer with a particular instruction-set architecture, then the fact that one of the hosts includes processors with the required instruction-set architecture while the other host does not require the management system to place the workload on the host with processors having the required instruction-set architecture. Alternatively, the management system might consider placing the workload on the other host provided that the other host includes a virtualization layer or other component that would allow for static or dynamic translation of the workload instructions, or a relevant portion of the workload instructions, to different instructions of the different instruction-set architecture that emulate the intended operations that would result from the original instructions being executed on the host having processors with the instruction-set architecture for which the workload was developed. The management system of a homogeneous distributed computer system would generally not need to carefully consider the host instruction-set architecture when selecting a host within a homogeneous distributed computer system. Of course, a workload developed for an instruction-set architecture different from the common instruction-set architecture within a homogeneous distributed computer system can still be run, but that decision would only be based on the ability of candidate hosts to translate all or a portion of the instructions of the workload to the different, common instruction-set architecture within the distributed computer system. By contrast, other types of characteristics, such as the amount of currently available processor bandwidth or memory need to be considered for each candidate host during placement of the workload even in a homogeneous distributed computer system.

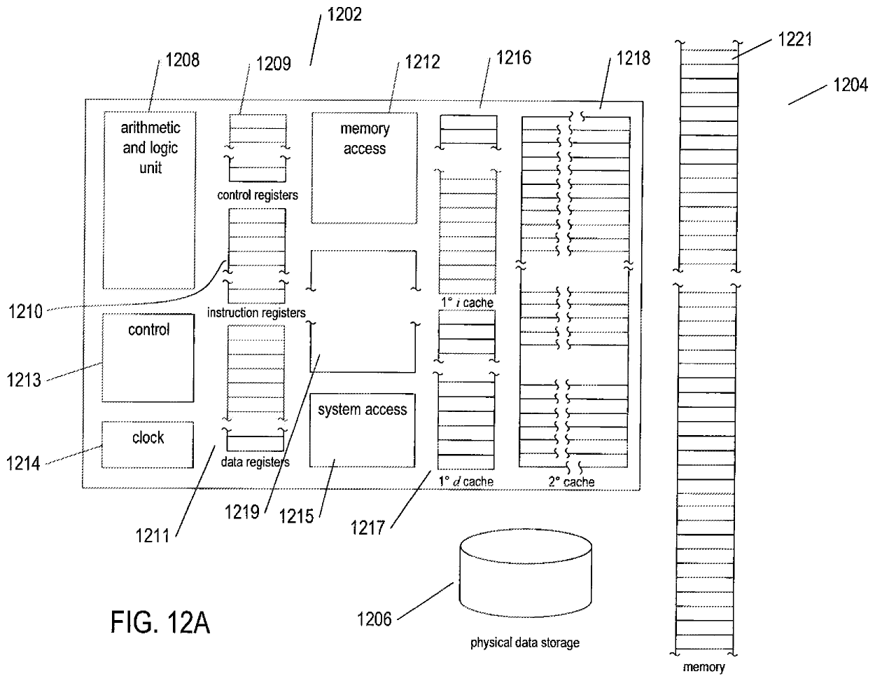

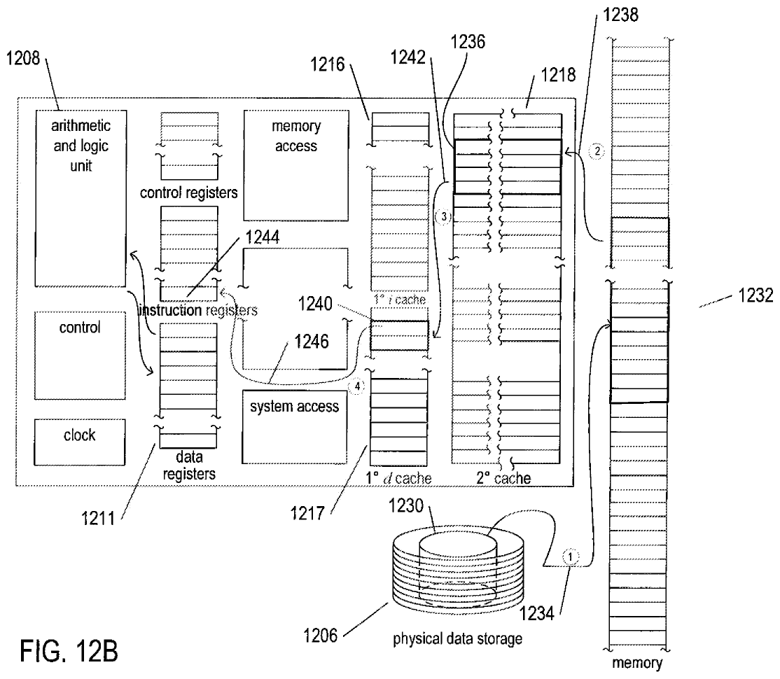

There are an enormous number of differences between the characteristics and parameters of heterogeneous hosts that may affect implementation of management systems for managing distributed computer systems containing heterogeneous hosts. In order to provide appreciation for these many differences, a brief overview of instruction-set architectures and a more detailed description of computer-system hardware is next provided, with reference to FIGS. 12A-17. These descriptions are not directed to a specific computer system or instruction-set architecture, but are provided only to indicate the many different types of characteristics and parameters that might be involved in host-selection decisions.

FIGS. 12A-B illustrate a hypothetical computer system. The hypothetical system includes a processor 1202, a memory 1204, and a physical data-storage device 1206. The processor includes an arithmetic and logic unit 1208, control registers 1209, instruction registers 1210, data registers 1211, a memory-access controller 1212, a control unit 1213 that coordinates operation and interoperation of the various processor components, a hardware clock 1214, a system-access controller 1215, a primary instruction cache 1216, a primary data cache 1217, a secondary combined data and instruction cache 1218, and other components represented by the rectangle of indeterminate size 1219 included in the block diagram of the processor 1202. The memory 1204 is represented as a linear address space, with each cell or element, such as cell 1221, representing a unit of memory storage, such as a 64-bit word.

FIG. 12B illustrates, using the example system shown in FIG. 12A, how data and instructions migrate from the physical data-storage device through memory into processor caches and registers in order to be executed and operated on, respectively, by the processor. In general, both data and instructions are stored in the non-volatile physical data-storage device 1206. Data blocks and sectors, represented in FIG. 12B by a thin cylinder 1230 comprising tracks read together by a multi-read disk head from multiple disk platters, is transferred under processor control to one or more blocks or pages of memory 1232. The data blocks contain computer instructions and data. The movement of instructions and data from the physical data-storage device to memory is represented by a first curved arrow 1234 in FIG. 12B. In order for instructions to be executed and data to be operated on, the instructions and data are moved from memory to the processor. First, assuming the memory block or page 1232 contains instructions, the block of instructions is moved to the secondary cache 1236, as represented by curved arrow 1238. A portion of the instructions is moved from the secondary cache to the primary instruction cache 1240, as represented by curved arrow 1242. A particular instruction is executed by moving the instruction from the primary cache to an instruction register 1244, as represented by arrow 1246. The instruction is then fetched from the instruction register by the arithmetic and logic unit 1208 and executed. Instructions that produce data values result in storage of computed data values in data registers. Similarly, data migrates from the physical data-storage device to memory, from memory to the secondary cache, from the secondary cache to the primary data cache 1217, and from the primary data cache to the data registers 1211. The processor operates on the data registers, as controlled by instructions fetched and executed from the instruction registers.

The instruction and data registers represent the most expensive and most quickly accessed data-storage units within the computer system. The next most expensive and next most quickly accessed storage components are the primary instruction cache 1216 and the primary data cache 1217. The secondary cache 1218 is somewhat less expensive and more slowly accessed. The memory 1232 is much less expensive and much less quickly accessed by the processor, and the physical data-storage device 1206 is the least expensive data-storage component, on a per-instruction or per-data-unit basis, and is much more slowly accessed by the computer system. The processor caches and registers are organized so that instructions that are repetitively executed within a short span of time, such as instructions within a tight loop of a routine, may reside in the instruction registers or the instruction registers combined with the primary instruction cache, in order to facilitate rapid iterative execution of the loop. Similarly, instructions of a longer, but repetitively executed routine tend to reside in the primary instruction cache or in a combination of the primary instruction cache and the secondary cache, in order to avoid the need to repetitively access instructions of the routine from memory. In similar fashion, the instructions of a large program or software component may reside, over long periods of time, within memory 1232, rather than being repetitively read into memory from the physical data-storage device. In modern computer systems, the address space corresponding to memory is virtual, having a much larger virtual length than the actual length of the physical address space represented by physical memory components, with data transferred back and forth from the physical data-storage device and memory, under processor control, in order to support the illusion of a much larger virtual address space than can be contained, at any particular point in time, in the smaller physical memory.

Any particular component or subsystem of the simple computer system may. over any given period of time, represent a computational bottleneck that limits the throughput of the computer system. For example, were the computer system to execute a tiny routine that can be completely stored within the instruction registers and that operates on only a few data items that can be stored in the data registers, the computational throughput would likely be limited by the speed of the arithmetic and logic unit and various internal communication pathways within the processor. By contrast, were the computing system executing a modestly sized program that could be stored within the secondary cache 1218 and that operated on data that could be stored in either the primary data cache or a combination of the primary data cache and the secondary cache, the computational throughput of the computer system may be limited by the processor control components and internal busses or signal paths through which data is transferred back and forth between the caches and registers. When the computer system runs a multitasking operating system that, in turn, runs multiple routines on behalf of multiple users, requiring instructions and data to be constantly moved between memory and processor caches, the throughput of the computer system may well be constrained and governed by the speed of a memory bus through which instructions and data pass between the memory and the processor and the processor and memory. In certain cases, when very large amounts of data are read in and modified from the physical data-storage device, the throughput of the computer system may be constrained by the speed of access to data within the physical data-storage device. In certain cases, the computational throughput may be limited by complex interactions between components while in other cases, computational throughput of the system may be limited by a single component or subsystem that represents a bottleneck within the computer system with respect to the tasks being carried out by the computer system. In large virtual data centers, many different components, subsystems, collections of discrete systems, networking infrastructure, and other subsystems and subcomponents may represent bottlenecks, under particular loads at particular times, within the complex, distributed virtual data centers.

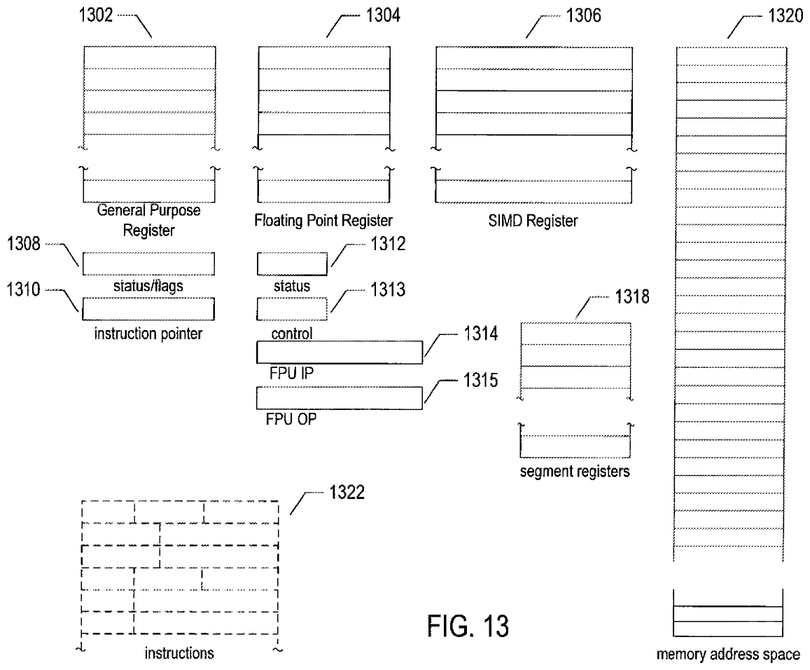

FIG. 13 illustrates an instruction-set architecture (“ISA”) provided by an example processor. The ISA commonly includes a set of general-purpose registers 1302, a set of floating-point registers 1304, a set of single-instruction-multiple-data (“SIMD”) registers 1306, a status/flags register 1308, an instruction pointer 1310, special status 1312, control 1313, and instruction-pointer 1314 and operand 1315 registers for floating-point instruction execution, segment registers 1318 for segment-based addressing, a linear virtual-memory address space 1320, and the definitions and specifications of the various types of instructions that can be executed by the processor 1322. The length, in bits, of the various registers is generally implementation dependent, often related to the fundamental data unit that is manipulated by the processor when executing instructions, such as a 16-bit, 32-bit, or 64-bit word and/or 64-bit or 128-bit floating-point words. When a computational entity is instantiated within a computer system, the values stored in each of the registers and in the virtual memory-address space together comprise the machine state, or architecture state, for the computational entity. While the ISA represents a level of abstraction above the actual hardware features and hardware resources of a processor, the abstraction is generally not too far removed from the physical hardware. As one example, a processor may maintain a somewhat larger register file that includes a greater number of registers than the set of general-purpose registers provided by the ISA to each computational entity. ISA registers are mapped by processor logic, often in cooperation with an operating system and/or virtual-machine monitor, to registers within the register file, and the contents of the registers within the register file may, in turn, be stored to memory and retrieved from memory, as needed, in order to provide temporal multiplexing of computational-entity execution.

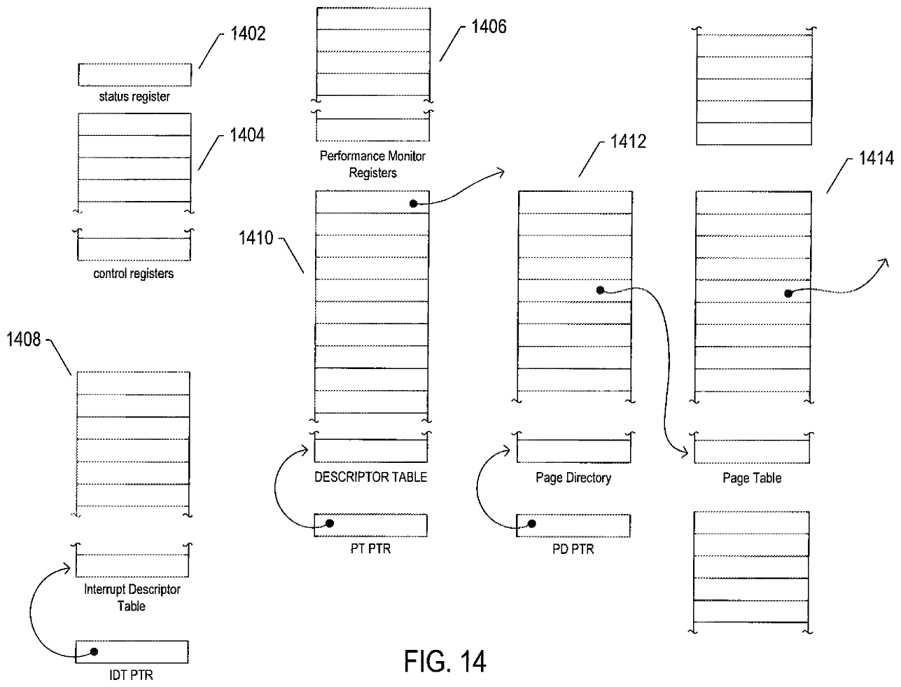

FIG. 14 illustrates an additional abstraction of processor features and resources used by virtual-machine monitors, operating systems, and other privileged control programs. These processor features, or hardware resources, can generally be accessed only by control programs operating at higher levels than the privilege level at which application programs execute. These system resources include an additional status register 1402, a set of additional control registers 1404, a set of performance-monitoring registers 1406, an interrupt-descriptor table 1408 that stores descriptions of entry points for interrupt handlers, the descriptions including references to memory descriptors stored in a descriptor table 1410. The memory descriptors stored in the descriptor table may be accessed through references stored in the interrupt-descriptor table, segment selectors included in virtual-memory addresses, or special task-state segment selectors used by an operating system to store the architectural state of a currently executing process. Segment references are essentially pointers to the beginning of virtual-memory segments. Virtual-memory addresses are translated by hardware virtual-memory-address translation features that ultimately depend on a page directory 1412 that contains entries pointing to page tables, such as page table 1414, each of which, in turn, contains a physical memory address of a virtual-memory page.

In many modern operating systems, the operating system provides an execution environment for concurrent execution of a large number of processes, each corresponding to an executing application program, on one or a relatively small number of hardware processors by temporal multiplexing of process execution. Temporal multiplexing provides an illusion, to each process, that the process enjoys full, unrestricted access to the capabilities of the one or more processors during its execution. However, processes execute for short periods of time and then wait, on queues, while other processes execute for similar short periods of time. Other types of operating systems, referred to as “real-time operating systems,” are more preemption based, so that processes do not execute only for rigidly impose time slices, but instead execute up to certain reasonable interruption points, with higher-priority processes generally interrupting lower-priority processes in order to provide generally deterministic and low latency for access to processor bandwidth. This is but one type of difference between different types of operating system.

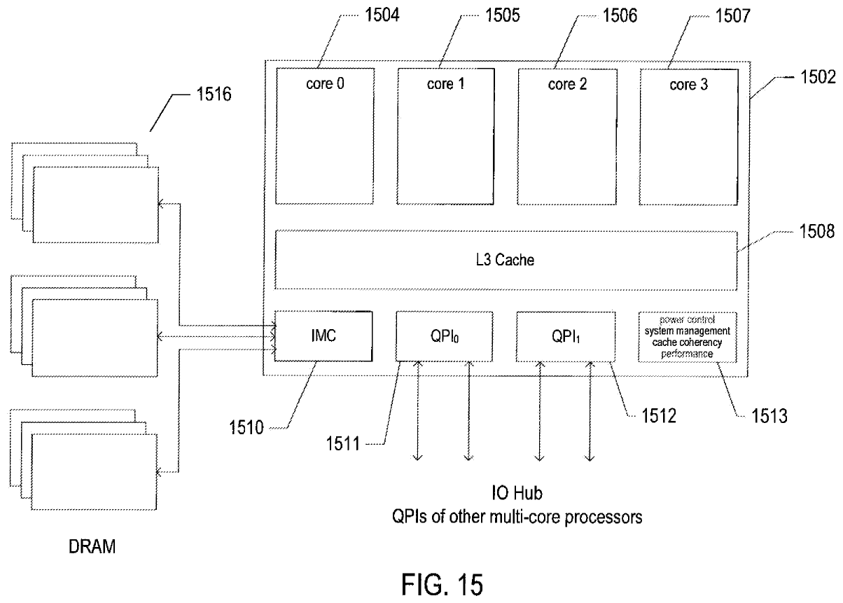

FIG. 15 illustrates an example multi-core processor. The multi-core processor 1502 includes four processor cores 1504-1507, a level-3 cache 1508 shared by the four cores 1504-1507, and additional interconnect and management components 1510-1513 also shared among the four processor cores 1504-1507. Integrated memory controller (“IMC”) 1510 manages data transfer between multiple banks of dynamic random access memory (“DRAM”) 1516 and the level-3 cache (“L3 cache”) 1508. Two interconnect ports 1511 and 1512 provide data transfer between the multi-core processor 1502 and an 10 hub and other multi-core processors. A final, shared component 1513 includes power-control functionality, system-management functionality, cache-coherency logic, and performance-monitoring logic.

Each core in a multi-core processor is essentially a discrete, separate processor that is fabricated, along with all the other cores in a multi-core processor, within a single integrated circuit. As discussed below, each core includes multiple instruction-execution pipelines and internal L1 caches. In some eases, each core also contains an L2 cache, while, in other cases, pairs of cores may share an L2 cache. As discussed further, below, SMT-processor cores provide for simultaneous execution of multiple hardware threads. Thus, a multi-SMT-core processor containing four SMT-processors that each supports simultaneous execution of two hardware threads can be viewed as containing eight logical processors, each logical processor corresponding to a single hardware thread.

The memory caches, such as the L3 cache 1508 and the multi-core processor shown in FIG. 15 is generally SRAM memory, which is much faster but also more complex and expensive than DRAM memory. The caches are hierarchically organized within a processor. The processor attempts to fetch instructions and data, during execution, from the smallest, highest-speed L1 cache. When the instruction or data value cannot be found in the L1 cache, the processor attempts to find the instruction or data in the L2 cache. When the instruction or data is resident in the L2 cache, the instruction or data is copied from the L2 cache into the L1 cache. When the L1 cache is full, instruction or data within the L1 cache is evicted, or overwritten, by the instruction or data moved from the L2 cache to the L1 cache. When the data or instruction is not resident within the L2 cache, the processor attempts to access the data or instruction in the L3 cache, and when the data or instruction is not present in the L3 cache, the data or instruction is fetched from DRAM system memory. Ultimately, data and instruction are generally transferred from a mass-storage device to the DRAM memory. As with the L1 cache, when intermediate caches are full, eviction of an already-resident instruction or data generally occurs in order to copy data from a downstream cache into an upstream cache.

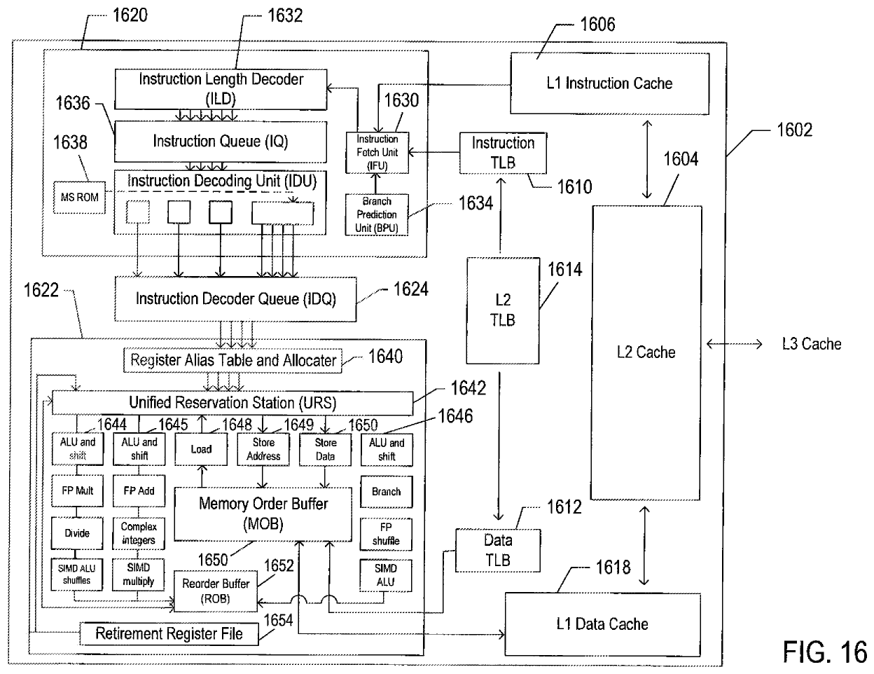

FIG. 16 illustrates the components of an example processor core. As with the descriptions of the ISA and system registers, with reference to FIGS. 13 and 14, and with the description of the multi-core processor, with reference to FIG. 15, the processor core illustrated in FIG. 16 is intended as a high-level, relatively generic representation of a processor core. Many different types of multi-core processors feature different types of cores that provide different ISAs and different constellations of system registers. The different types of multi-core processors may use quite different types of data structures and logic for mapping virtual-memory addresses to physical addresses. Different types of multi-core processors may provide different numbers of general-purpose registers, different numbers of floating-point registers, and vastly different internal execution-pipeline structures and computational facilities.

The processor core 1602 illustrated in FIG. 16 includes an L2 cache 1604 connected to an L3 cache (1508 in FIG. 15) shared by other processor cores as well as to an L1 instruction cache 1606 and an L1 data cache 1618. The processor core also includes a first-level instruction translation-lookaside buffer (“TLB”) 1610, a first-level data TLB 1612, and a second-level, universal TLB 1614. These TLBs store virtual-memory translations for the virtual-memory addresses of instructions and data stored in the various levels of caches, including the L1 instruction cache, the L1 data cache, and L2 cache. When a TLB entry exists for a particular virtual-memory address, accessing the contents of the physical memory address corresponding to the virtual-memory address is far more computationally efficient than computing the physical-memory address using the previously described page directory and page tables.

The processor core 1602 includes a front-end in-order functional block 1620 and a back-end out-of-order-execution engine 1622. The front-end block 1620 reads instructions from the memory hierarchy and decodes the instructions into simpler microinstructions which are stored in the instruction decoder queue (“1DQ”) 1624. The microinstructions are read from the IDQ by the execution engine 1622 and executed in various parallel execution pipelines within the execution engine. The front-end functional block 1620 include an instruction fetch unit (“IFU”) 1630 that fetches 16 bytes of aligned instruction bytes, on each clock cycle, from the L1 instruction cache 1606 and delivers the 16 bytes of aligned instruction bytes to the instruction length decoder (“ILD”) 1632. The IFU may fetch instructions corresponding to a particular branch of code following a branch instruction before the branch instruction is actually executed and, therefore, before it is known with certainty that the particular branch of code will be selected for execution by the branch instruction. Selection of code branches from which to select instructions prior to execution of a controlling branch instruction is made by a branch prediction unit 1634. The ILD 1632 processes the 16 bytes of aligned instruction bytes provided by the instruction fetch unit 1630 on each clock cycle in order to determine lengths of the instructions included in the 16 bytes of instructions and may undertake partial decoding of the individual instructions, providing up to six partially processed instructions per clock cycle to the instruction queue (“IQ”) 1636. The instruction decoding unit (“IDU”) reads instructions from the IQ and decodes the instructions into microinstructions which the IDU writes to the IDQ 1624. For certain complex instructions, the IDU fetches multiple corresponding microinstructions from the MS ROM 1638.

The back-end out-of-order-execution engine 1622 includes a register alias table and allocator 1640 that allocates execution-engine resources to microinstructions and uses register renaming to allow instructions that use a common register to be executed in parallel. The register alias table and allocator component 1640 then places the microinstructions, following register renaming and resource allocation, into the unified reservation station (“URS”) 1642 for dispatching to the initial execution functional units 1644-1646 and 1648-1650 of six parallel execution pipelines. Microinstructions remain in the URS until all source operands have been obtained for the microinstructions. The parallel execution pipelines include three pipelines for execution of logic and arithmetic instructions, with initial functional units 1644-1646, a pipeline for loading operands from memory, with initial functional unit 1648, and two pipelines, with initial functional units 1649-1650, for storing addresses and data to memory. A memory-order buffer (“MOB”) 1650 facilitates speculative and out-of-order loads and stores and ensures that writes to memory take place in an order corresponding to the original instruction order of a program. A reorder buffer (“ROB”) 1652 tracks all microinstructions that are currently being executed in the chains of functional units and, when the microinstructions corresponding to a program instruction have been successfully executed, notifies the retirement register file 1654 to commit the instruction execution to the architectural state of the process by ensuring that ISA registers are appropriate updated and writes to memory are committed.

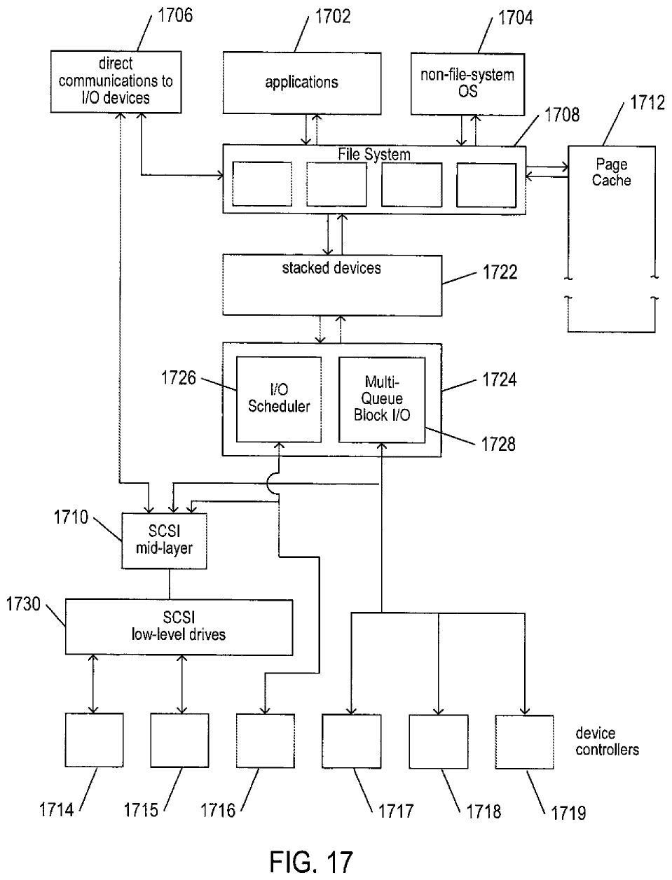

FIG. 17 illustrates the storage stack within a computer system. The storage stack is a hierarchically layered set of components that interconnect application programs, portions of an operating system, and remote computational entities with the controllers that control access to, and operation of, various types of data-storage devices. In FIG. 17, executing application programs are represented by rectangle 1702, the non-file-system portion of an operating system is represented by rectangle 1704, and remote computational entities accessing data-storage facilities of the local computer system through communications devices are represented by rectangle 1706. The applications and non-file-system portions of the operating system 1702 and 1704 access local data-storage devices through the file system 1708 of the operating system. Remote processing entities 1706 may access data-storage devices through the file system or may directly access a small computer system interface (“SCSI”) middle layer 1710. The file system maintains a page cache 1712 for caching data retrieved from storage devices on behalf of applications, non-file-system OS components, and remote computational entities. The file system, in turn, accesses the low-level data-storage device controllers 1714-1719 through a stacked-devices layer 1722 and block layer 1724. The stacked-devices layer 1722 implements various types of multi-device aggregations, such as a redundant array of independent disks (“RAID”), that provide for fault-tolerant data storage. The block layer 1724 stores data blocks in, and retrieves data blocks from, data-storage devices. Traditional devices with single input and output queues are accessed via an I/O scheduler 1726 while more modern, high-throughput devices that provide for large numbers of input and output queues from which I/O requests can be fetched, in parallel, for parallel execution of the I/O requests are accessed through a multi-queue block I/O component 1728. The SCSI midlayer 1710 and lower-level SCSI drives 1730 provide access to the device controllers for data-storage devices with SCSI interfaces 1714-1715. Other types of low-throughput FO device controllers 1716 that do not provide the SCSI interface are directly accessed by the I/O scheduler component 1726. The device controllers for modern, multi-queue, high-throughput data-storage devices 1717-1719 are accessed directly by the multi-queue block I/O component 1728.

As should be apparent from the following discussion with reference to FIGS. 12A-17, there are many different possible differences, at many different levels, between the hardware components and instruction-set architectures of one host server and those of another, dissimilar host server. The decisions made by a management system in deciding on which host of a distributed computing system to place a particular workload can thus be quite complex. Many different factors may need to be considered. As mentioned above, the instructions of a workload have generally been compiled from high-level programs to run on particular instruction-set architectures, and hosts with instruction-set architectures that differ from the intended target instruction-set architecture may need to translate all or a certain portion of those instructions to instructions that can be executed on the different instruction-set architecture. Particular instruction-set-architectures within a family of instruction-set architectures may also differ from one another. But there may be more complicated dependencies. For example, a workload may have been developed to make use of hardware threading for process threads and may have been fine-tuned to enable collocating different types of processes or threads in each of multiple different processors. Hosting this workload on a host that does not provide the same type of hardware threading may result in suboptimal performance. It may be, depending on the implementation of a management system for a heterogeneous distributed computer system, that only certain relatively high-level characteristics and parameters of different hosts are considered when placing and migrating workloads while, in other implementations, very complex decisions may be made with regard to numerous relatively low-level and fine-grain architectural differences between heterogeneous hosts. These may include differences in instruction-set-architecture-level security features, the type and availability of graphical-processing-units (“GPUs”), internal bus bandwidths and data-storage components, and literally hundreds or more other such characteristics and differences. As another example, it may be desirable to collocate a workload with a datastore or instance of a database-management service to minimize communications overheads. It may also be desirable to place application instances in particular geographically located data centers within regions in which many clients access the application instances, again in order to minimize network overheads. It is often the case that workloads are placed, and even later migrated, to hosts with lowest hosting fees and service fees, to minimize the operational costs of the application. Additional considerations may include geographical dispersal for disaster-risk amelioration and dispersal among multiple data centers for increased fault-tolerance. Yet additional considerations may involve security concerns that can be partially ameliorated by placing workloads in certain jurisdictions and in data centers that support highly-secure internal operations and networking to external entities.

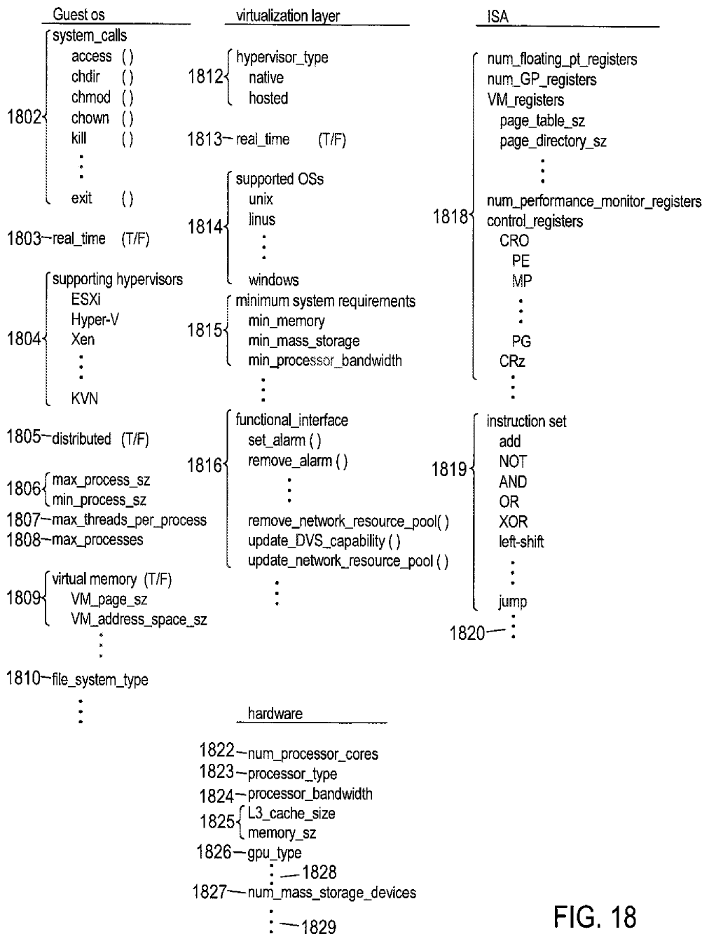

FIG. 18 illustrates some of the characteristics and parameters for each of the main layers of hosts that may differ between heterogeneous hosts and that may factor into placement-motivated and migration-motivated host-selection decisions. Numerous occurrences of ellipses in FIG. 18 indicate there are many additional different types of characteristics and parameters that might be relevant to host-selection decisions. Guest-operating-system characteristics and parameters may include the set of system calls provided by the guest operating system 1802, whether or not the guest operating system is a real-time operating system 1803, what type of hypervisors can support virtual machines including the guest operating systems 1804, whether or not the guest operating system is a distributed operating system 1805, minimum and maximum sizes of processes, in terms of memory and other computational resources, supported by the guest operating system 1806, the maximum number of threads per process 1807, the maximum number of processes 1808, whether or not virtual memory is provided and basic characteristics of the virtual memory 1809, the type of file system 1810, and many other such characteristics and parameters. The virtualization layer characteristics and parameters may include the type of hypervisor 1812, whether or not the hypervisor provides support for real-time guest operating systems 1813, the different guest operating systems supported by the hypervisor 1814, various types of system requirements 1815, and the functional interface for the virtualization layer 1816. Instruction-set-architecture characteristics and parameters may include the types and numbers of registers 1818, the different instructions provided by the instruction-set architecture 1819, and a very large number of other types of characteristics and parameters 1820 that can be inferred from the above description of construction-set architectures and computer hardware. Computer hardware characteristics and parameters may include the number of processor cores 1822, the processor type 1823, the total processing bandwidth 1824, cache and memory sizes 1825, graphical-processing-unit type 1826, number of mass-storage devices 1827, and many additional characteristics and parameters as indicated by ellipses 1828 and 1829. Again, whether or not each of these different types of characteristics and parameters are considered during host-selection decisions by the management system may vary from implementation to implementation and from workload to workload. Many of the characteristics and parameters may not be relevant due to virtualization of computational resources provided by hypervisors, but, in other cases, they may nonetheless be critical determinants of VM performance.

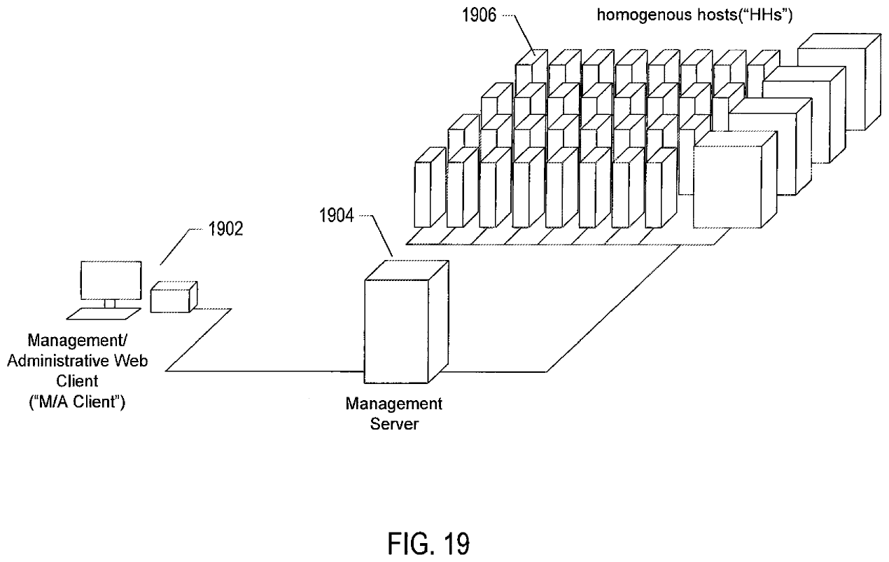

FIG. 19 shows components of one currently available VMware management system that manages a distributed computer system. The management system is accessed by a management/administration web client 1902 and accesses a management-interface service provided by a management server 1904. The management server is shown as a standalone system, but is generally implemented as one or more management server executables running within one or more virtual machines within the distributed computer system. The management server manages multiple homogeneous hosts (“HHs”), such as host 1906, that execute homogeneous host (“HH”) hypervisors.

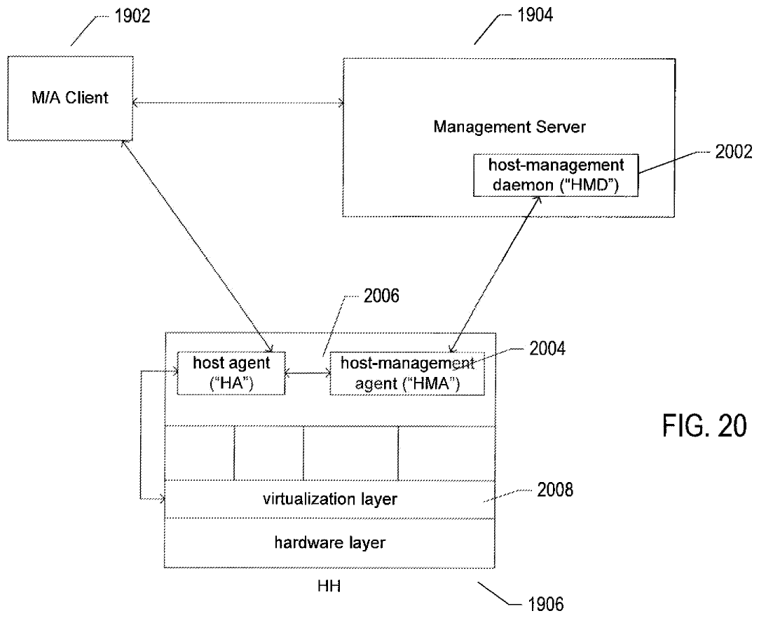

FIG. 20 shows communications between management-system components. As shown in FIG. 20, the management administration web client 1902 accesses management services provided by the management server 1904, which may involve communication between the management server and one or more HHs. Communications between the management server and one or more HHs are carried out between a host-management daemon (“HMD”) 2002 in the management server and host-management agents (“HMAs”) 2004 running within each HH. In essence, a HMA is a management-server agent running within the HH. The HMA, in turn, communicates with a host agent (“HA”) 2006 provided by the HH hypervisor 2008 within the HH. The management administration web client 1902 can alternatively directly connect to the HA. Communications among management-system components may be based on service-oriented protocols and/or stateless protocols.

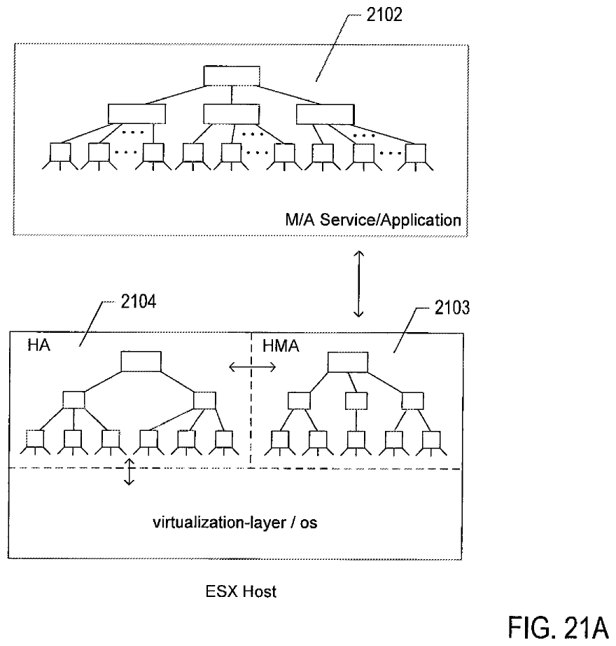

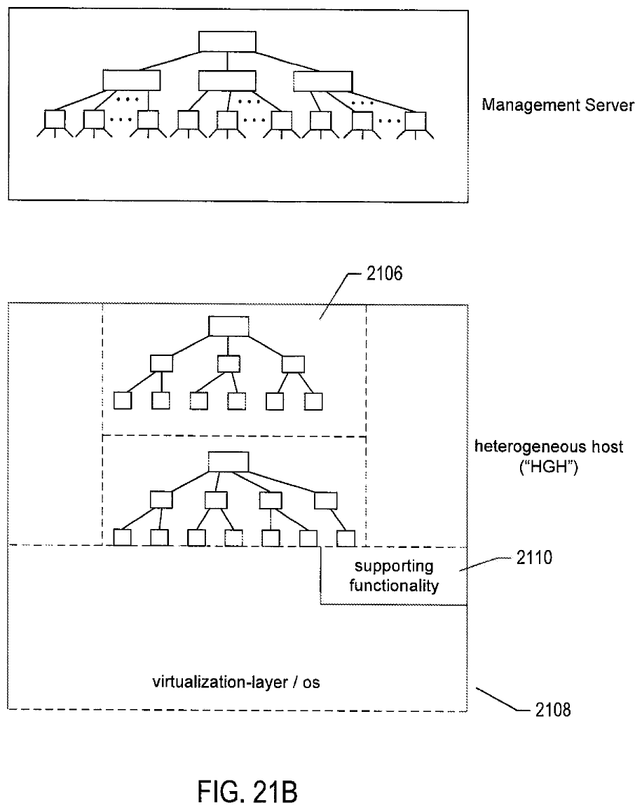

FIG. 21A illustrates the managed-object-based interfaces between the management server and an HH. The management server, HMA, and HA management interface all employ managed objects to implement management operations. Managed objects are defined by a hierarchical set of classes and class instances. These are represented, in FIG. 21A, by tree-like hierarchies 2102-2104. The various management operations carried out by the management server are implemented as calls to managed-object methods, including remote calls to managed-object methods implemented by the HMAs and HA. The types of managed objects and managed-object methods, and other details of these implementations, are beyond the scope of the current discussion. An important point for the current discussion is that the managed-object implementations are relatively abstract, with the managed-object methods comprising a set of generic operations with specific lower-level implementations. Thus, the management server may remotely call a managed-object method, implemented by the HMA within an HH, to halt execution of a particular virtual machine. The HMA may then, in turn, call a managed-object method implemented by the HA to instruct the HH hypervisor to carry out the specified virtual-machine halt operation.

FIG. 21B illustrates extending management-server management to heterogeneous hosts (“HGHs”). For much of the management-server management functionality which, as discussed above, is implemented using calls to managed-object methods, no changes are necessary in order to extend management-server management to HGHs. Instead, a HGH agent 2106 that implements the managed-object-method implementations of the HMA and HA management interface is developed for, and included in the, the HGH 2208. In certain cases, additional supporting functionality 2110 is also included for emulation of HH functionalities, such as heart-beat generators. But, because the managed-object-based interfaces are abstract, by developing managed-object-method implementations that interface to the HGH hypervisor within an HGH, the interface between the management server and HGH can remain largely unaltered. More importantly, much of the complex logic within the management server can be applied, without modification, to a heterogeneous distributed computer system. Thus, rather than attempting to design and implement an entirely new management system, an existing management system can be modified, improved, and extended to enable the existing management system to manage heterogeneous distributed computer systems by developing suitable agents for HGHs.

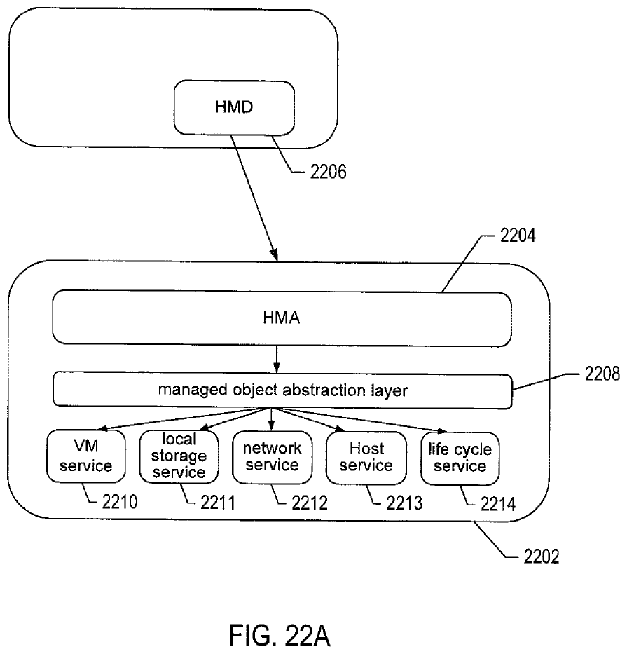

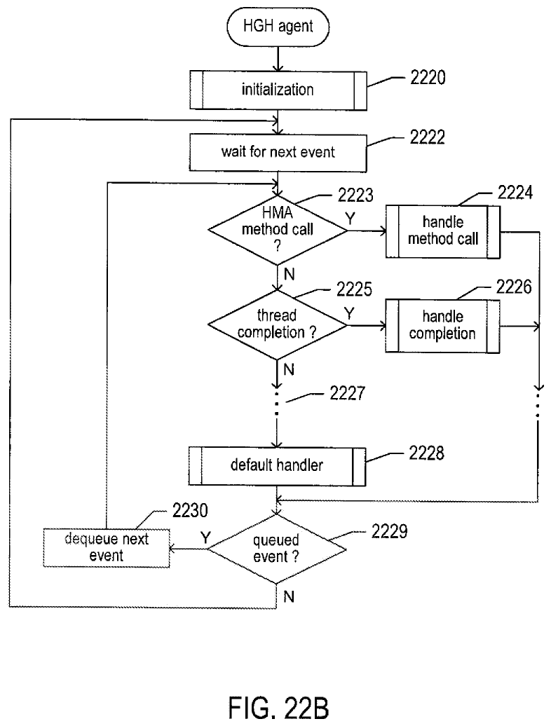

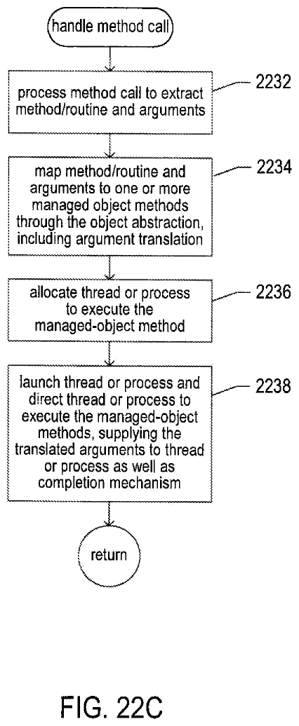

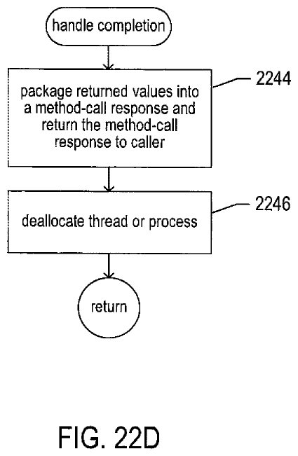

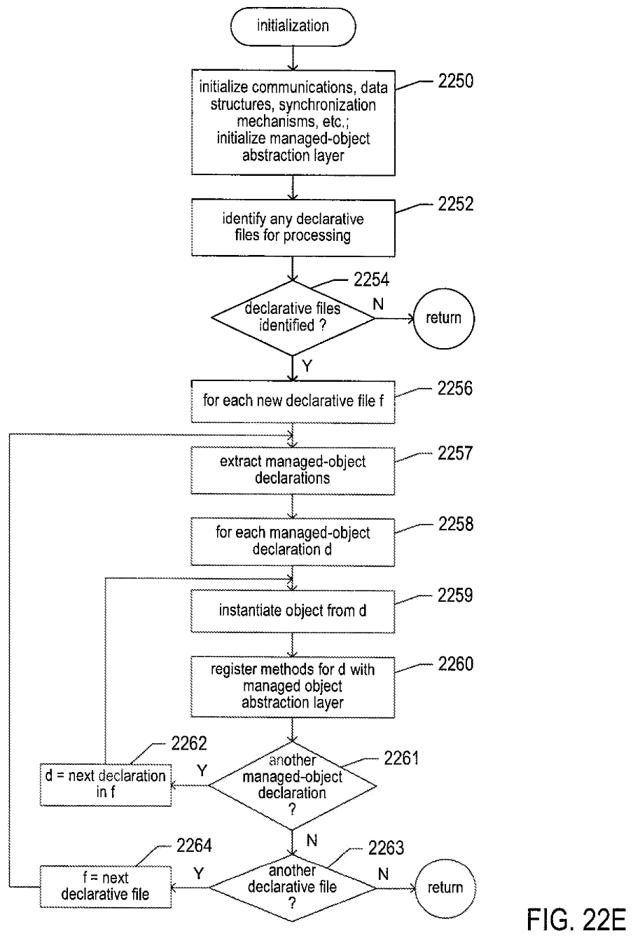

FIGS. 22A-E provide additional details about one implementation of the HGH agent discussed above with reference to FIG. 21B. As shown in FIG. 21A, the HGH agent 2202 includes an HMA interface 2204 and logic that receives operation requests from the HMD 2206, carries out the operation requests, and returns responses to the HMD. The HGH agent 2202 carries out the requested operations by mapping the requested operations through a managed-object abstraction layer 2208 to one or more managed-object methods of one or more particular managed objects of one or more managed-object-implemented services 2210-2214.

FIG. 22B illustrates one implementation of HGH-agent logic incorporated in a routine “agent.” In step 2220, the routine “HGH agent” calls, on power-up and restart of the EXI agent, an initialization routine. Then, in an event-handling loop of steps 2222-2230, the routine “HGH agent” waits for a next event to occur, in step 2222 and then determines the type of the next occurring event and processes the next occurring event. When the next occurring event is reception of an HMA method call from the HMD, as determined in step 2223, a routine “handle method call” is called, in step 2224. Otherwise, when the next occurring event is a thread-completion event, as determined in step 2225, a routine “handle completion” is called, in step 2226. Ellipsis 2227 indicates that the routine “HGH agent” may detect and handle various additional types of events. A default handler is called, in step 2228, to handle rare and unexpected events. When a next event has been queued for handling, as determined in step 2229, the next event is dequeued, in step 2230, and control returns to step 2223. Otherwise, control returns to step 2222, where the routine “HGH agent” waits for the occurrence of a next event.

FIG. 22C provides a control-flow diagram for the method “handle method call,” called in step 2224 of FIG. 22B. In step 2232, the routine “handle method call” processes a received method call to extract a method/routine indication along with supplied arguments. In step 2234, the routine “handle method call” maps the extracted method/routine indication and arguments to one or more managed-object methods through the managed-object abstraction layer, including carrying out any argument translations needed for invoking the managed-object methods. In step 2236, the routine “handle method call” allocates a thread or process to execute the managed-object method. In step 2238, the routine “handle method call” launches the thread or process, in the case that the thread or process is not already executing, and directs the thread or process to execute the managed-object methods, supplying the received arguments and/or translated arguments along with a reference to a completion mechanism by which the HGH agent receives an execution-completion notification from the thread or process.

FIG. 22D provides a control-flow diagram for the “handle completion” routine called in step 2226 of FIG. 22B. In step 2244, the routine “handle completion” packages return values received from the thread or process that executed one or more managed-object methods corresponding to a method call into a method-call response and returns the method-call response to the calling entity, generally an HMD. The association between the completion event and the calling entity is, in certain implementations, indicated through the completion mechanism and, in other implementations, extracted from stored information identified through an identifier returned through the completion mechanism. In step 2246, the routine “handle completion” deallocates the thread or process associated with the completion event. In certain implementations, the thread or process is terminated while, in other implementations, the thread or process is returned to a pool of active threads and processes that can be reallocated for handling subsequently received HMA method calls.

FIG. 22E provides a control-flow diagram for the routine “initialization,” called in step 2220 of FIG. 22B. This routine is called upon power up or restart of the HGH agent. In step 2250, the routine “initialization” initializes communications, data structures, synchronization mechanisms, and other such entities and processes needed for operation of the HGH agent. In addition, the routine “initialization” initializes the managed-object abstraction layer (2208 in FIG. 22A). In certain implementations, the managed-object abstraction layer is associated with stored information regarding previously registered managed objects, and automatically reinstantiates and reinitializes the managed objects using the stored information. In a first initialization of the HGH agent, the managed-object abstraction layer instantiates and initializes managed objects declared in a declarative file, and in each subsequent initialization, may process additional declarative files received by the HGH agent to provide for additional managed objects. In step 2252, the routine “initialization” identifies any declarative files that have not yet been processed. When one or more declarative files are identified for processing, as determined in step 2254, the routine “initialization” processes the declarative files in the nested for-loops of steps 2256-2264. In the outer for-loop of steps 2256-2264, each declarative file f to be processed is considered. In step 2257, the routine “initialization” extracts the managed-object declarations from the currently considered declarative file f. Then, in the inner for-loop of steps 2258-2262, each of the extracted managed-object declarations d is processed. In step 2259, a managed object is instantiated using the currently considered managed-object declaration d and, in step 2260, the methods associated with the instantiated object are registered with the managed-object abstraction layer.

The declarative files may be automatically generated, manually generated, or generated by both automated and manual processes. In certain implementations, the declarative files are automatically generated and then reviewed by the human administrators and managers to ensure correctness.

While development of agents for HGHs provides a straightforward path to extending a management system designed for management of a homogeneous distributed computer system to managing a heterogeneous distributed computer system, new logic for selecting hosts for workload placement and virtual-machine migration is required, since, as discussed above, there are potentially many additional considerations that may be involved in selecting suitable hosts for particular workloads and virtual machines. The remaining discussion in the current document is directed to a host-selection routine that can be incorporated into an extended management system to provide for workload placement and virtual-machine migration across heterogeneous hosts.

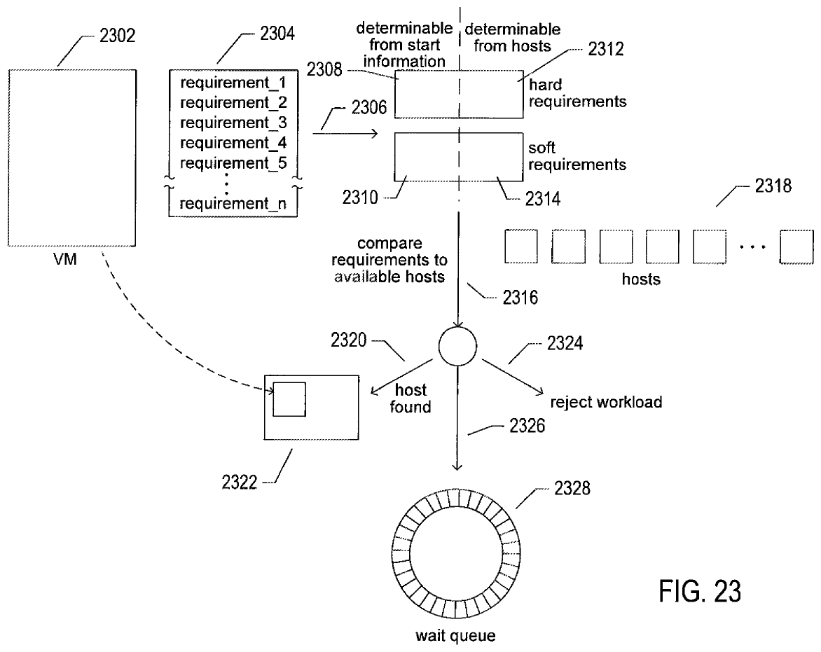

FIG. 23 illustrates the currently disclosed host-selection process carried out by a management system for a heterogeneous distributed computer system during workload-and/or-virtual-machine placement and virtual-machine-migration operations. On the left-hand side of FIG. 23, a virtual machine 2302 representing a workload to be placed within a distributed computer system or representing a virtual machine that needs to be migrated to a different host is shown along with a set of host requirements 2304. These host requirements specify a need for particular features or capabilities or particular parameter values or parameter-value ranges. The host requirements may be determined by analyzing a workload and/or virtual machine, from specifications provided for the workload and/or virtual machine by a manager or administrator, or, in the case of a virtual-machine migration, may be at least partially retrieved from a data store. As discussed above, particular implementations of the host-selection logic may consider different types of requirements at different levels of granularity and detail. Host requirements may specify only relatively high-level requirements, such as the type of hypervisor present within the host, or may specify very detailed requirements, including whether or not the instruction-set architecture of the host features particular types of instructions and/or registers and particular security features.

In a first step, represented by arrow 2306, the host requirements are logically partitioned into four different sets: (1) hard requirements that can be evaluated using stored host information 2308; (2) soft requirements that can be evaluated using stored host information 2310; (3) hard requirements that require information obtained from a host to be evaluated with respect to that host 2312; and (4) soft requirements that require information obtained from a host to be evaluated with respect to that host 2314. A hard requirement is a specific requirement that cannot be alternatively satisfied. By contrast, a soft requirement may generally be satisfied by alternative approaches. One example of a soft requirement is a requirement for a particular instruction-set architecture. This requirement, as discussed above, can be satisfied by selecting a host with the particular instruction-set architecture or, alternatively, by selecting a host that can perform static or dynamic instruction translation. One example of a hard requirement may be a requirement that a particular type of hypervisor be used by the host, assuming that the host cannot run more than one hypervisor and that one hypervisor cannot emulate another. This logical partitioning may be explicit or implicit, and is generally implementation specific as well dependent on the distributed computer system and on the type of workloads run by it.

Next, in a step represented by arrow 2316, the host requirements are evaluated with respect to the hosts of the distributed computer system 2318. As a result of the evaluation, three different outcomes are possible. In a first outcome, represented by arrow 2320, a suitable host is found for the virtual machine and the virtual machine is subsequently placed on, or migrated to, the selected host 2322. In a second outcome, represented by arrow 2324, the host-selection process determines that no host within a distributed computer system can host the virtual machine within a reasonable timeframe, and therefore hosting of the virtual machine is rejected. In a third outcome, represented by arrow 2326, there are no currently available hosts for hosting the virtual machine, but there are hosts that could possibly host a virtual machine within a reasonable timeframe, and therefore the hosting request is placed on a wait queue 2328 for servicing when a suitable host becomes available.

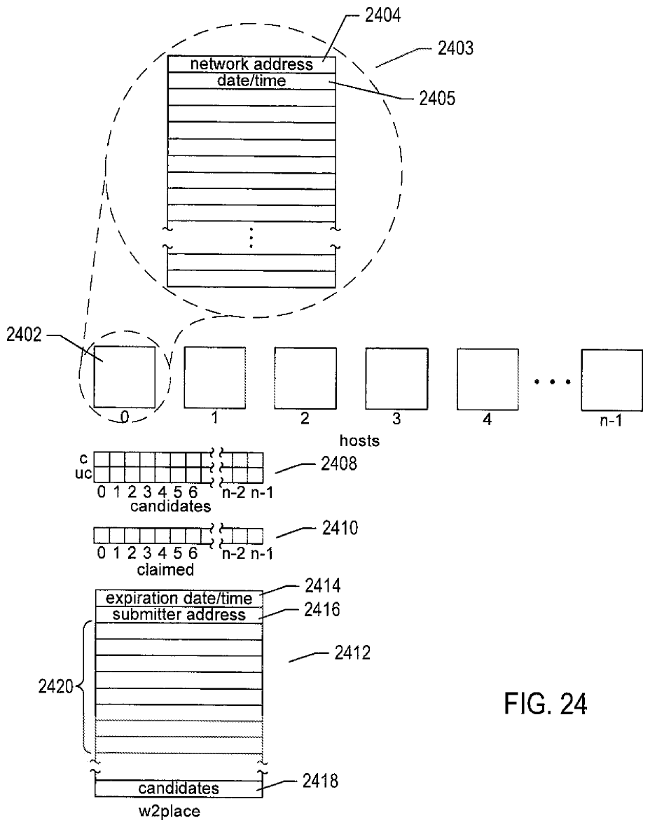

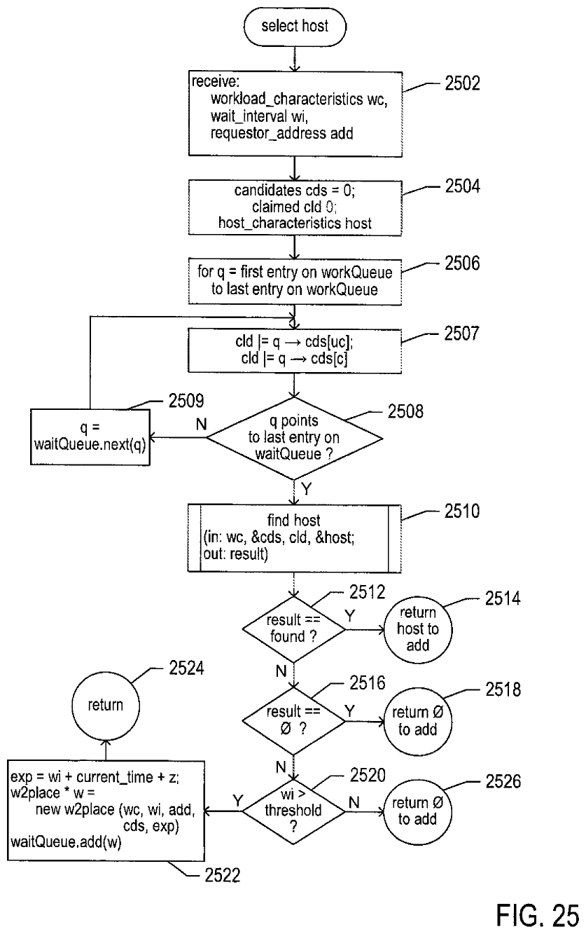

FIG. 24 illustrates several data structures used in a description of a routine “select host” with reference to FIGS. 25-29. The hosts within a distributed computer system are each represented by a host data structure, such as host data structure 2402 shown in greater detail in inset 2403. The host data structure may include one or more network addresses for the agent within the host 2404, a timestamp indicating when the host became available 2405, and many other types of information, including parameter values and characteristics of the host, as discussed above. The host data structures for the hosts of the distributed computer system may be contained in an array or list. In FIG. 24, the host data structures are indexed from 0 to n−1, where n is the total number of hosts in the distributed computer system. The information needed for evaluating the requirements in partitions 2308 and 2310, discussed above with respect to FIG. 23, are contained in the host data structures. A two-dimensional bit array 2408 of type candidates indicates the candidacy status of each host with respect to a particular virtual machine or workload. A first bit array, the elements of which have a first index c, indicates whether or not each of the hosts is a conditional candidate, meaning that some alternative method or feature must be used by the host in order to be able to host a particular workload or virtual machine, such as binary translation of workload instructions. Since these alternative methods are associated with performance and efficiency costs, it would be preferable to instead find a host that can be used as is, without need for such alternative methods or features. A second bit array, the elements of which have a first index uc, indicates whether or not each of the hosts is an unconditional candidate, meaning that the host is able to host the workload or virtual machine without needing to use undesirable alternative methods or conditions. A one-dimensional bit array of type claimed 2410 indicates whether or not each of the hosts has already been conditionally claimed by another waiting workload or virtual machine. Finally, a data structure of type w2place 2412 includes an expiration timestamp 2414, a network address for a requester 2416, and a candidates data structure 2418 along with many additional characteristic indications and parameter values that specify the requirements for a workload and/or virtual machine 2420.

FIGS. 25-29 provide control-flow diagrams for a routine “select host” that implements host-selection logic for a management system and for the routines “find host” and “eval host” that are called to implement the routine “select host.” The routine “select host” is generally called asynchronously, since a selected host may not be immediately returned to the calling entity, or requester. However, in certain cases, a result is immediately and synchronously returned. In step 2502, the routine “select host” receives a set of workload characteristics for a workload and/or virtual machine wc, a maximum wait interval wi that can be tolerated for placing or migrating the virtual machine, and a process identifier, network address, or other communications address for a requesting entity that has requested placement or migration of the virtual machine. It is assumed that the workload characteristics wc are, or can be easily transformed into, a set of requirements for candidate hosts. Thus, wc can be considered to be equivalent to the host requirements 2304 shown in FIG. 23, and the phrase “workload characteristics” is synonymous, in the following discussion, with the phrase “host requirements.” In step 2504, the routine “select host” initializes a candidates data structure cds to all zeros, initializes a claimed data structure cld to all zeros, and declares a host_characteristics data structure host for storing characteristics and parameter values for a particular host. In the for-loop of steps 2506-2509, each entry in the wait queue (2328 in FIG. 23) is considered. In step 2507, a bitwise OR operation is performed on the claimed data structure cld and the candidates data structure in the currently considered wait-queue entry to set elements to 1 or TRUE in the claimed data structure that correspond to hosts that are candidates for hosting the virtual machine represented by the currently considered wait-queue entry. At the completion of the for-loop of steps 2506-2509, the data structure claimed indicates those hosts that cannot be considered candidates for hosting the workload and/or virtual machine for which the routine “select host” is attempting to identify an available host within the distributed computer system, since the hosts indicated by the data structure claimed should be first made available to the waiting workloads and/or virtual machines. In step 2510, the routine “select host” calls a routine “find host” to identify an available host in the distributed computer system for the received workload a virtual machine represented by the workload characteristics included in wc. The routine “find host” returns a result. When the value of the returned result is found, as determined in step 2512, the host_characteristics data structure host is returned to the requester, or caller of the routine “select host,” in a synchronous return step 2514. When the return result is a null value of some type, as determined in step 2516, a null value is returned to the requester in a synchronous return step 2518. Otherwise, when the received wait interval wi is greater than a threshold value, as determined in step 2520, an expiration timestamp exp is computed for the received virtual machine, a new w2place data structure w is allocated and initialized for the received virtual machine, and the data structure w is queued to the wait queue in step 2522, after which the routine “select host” carries out an asynchronous return in step 2524. When the received wait interval wi is not greater than a threshold value, as determined in step 2520, a null value is returned to the requester in a synchronous return step 2526.

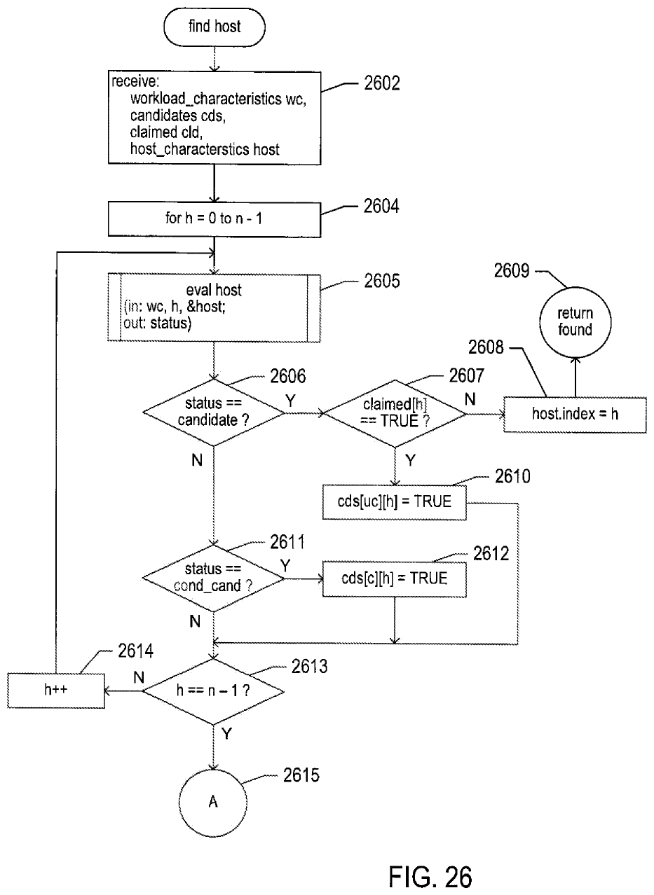

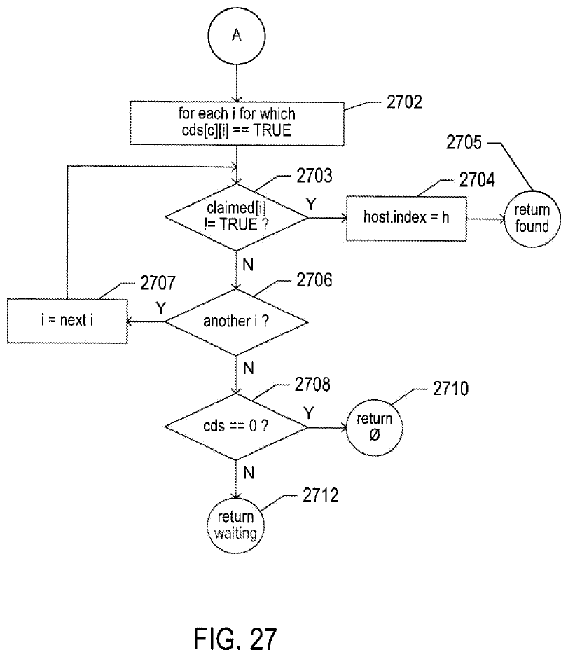

FIGS. 26-27 provide a control-flow diagram for the routine “find host,” called in step 2510 of FIG. 25. In step 2602, the routine “find host” receives a set of workload characteristics for a workload or virtual machine we, a candidates data structure cds, a claimed data structure cld, and a host_characteristics data structure host. The data structures cds and host are passed by reference. In the for-loop of steps 2604-2614, the routine “find host” considers each host in the distributed computer system. In step 2605, the routine “find host” calls the routine “eval host” for the currently considered host. The routine “eval host” returns a status. When the returned status is candidate, as determined in step 2606, the routine “find host” determines, in step 2607, whether or not the currently considered host has been claimed by a virtual machine on the wait queue. If not, then the routine “find host” updates the host_characteristics data structure host with the index of the currently considered host, in step 2608, and returns the result found in step 2609. When the currently considered host has been claimed, as determined in step 2607, the bit in the unconditional bit array of the candidates data structure cds corresponding to the host is set, in step 2610, to indicate that the host could be a candidate host for the currently considered virtual machine. Otherwise, when the returned status is cond_cand, as determined in step 2611, the bit in the conditional bit array of the candidates data structure cds corresponding to the host is set, in step 2612, to indicate that the host is a conditional candidate host for the currently considered virtual machine. A conditional candidate is one and that would require certain conditions in the host, such as the availability of binary translation for workload instructions. Conditional candidates are not immediately used for hosting the workload, since they involve additional types of functionalities that might be avoided were an unconditional candidate host to be found. Following completion of the for-loop of steps 2604-2614, control flows to step 2702 of FIG. 27. In the for-loop of steps 2702-2707, each of the conditional candidates identified for the received workload or virtual machine is considered, since no unconditional candidate was found in the for-loop of steps 2604-2614. If the host representing a conditional candidate has not been claimed by another virtual machine on the wait queue, as determined in step 2703, the host_characteristics data structure host is updated with the index of the currently considered conditional-candidate host, in step 2704, and the result found is returned in step 2705. Following completion of the for-loop of steps 2702-2707, the routine “find host” determines whether or not any candidate hosts for the received virtual machine or workload have been identified, in step 2708. If not, the routine “find host” returns a null value in step 2710. Otherwise, the routine “find host” returns a waiting value in step 2712.

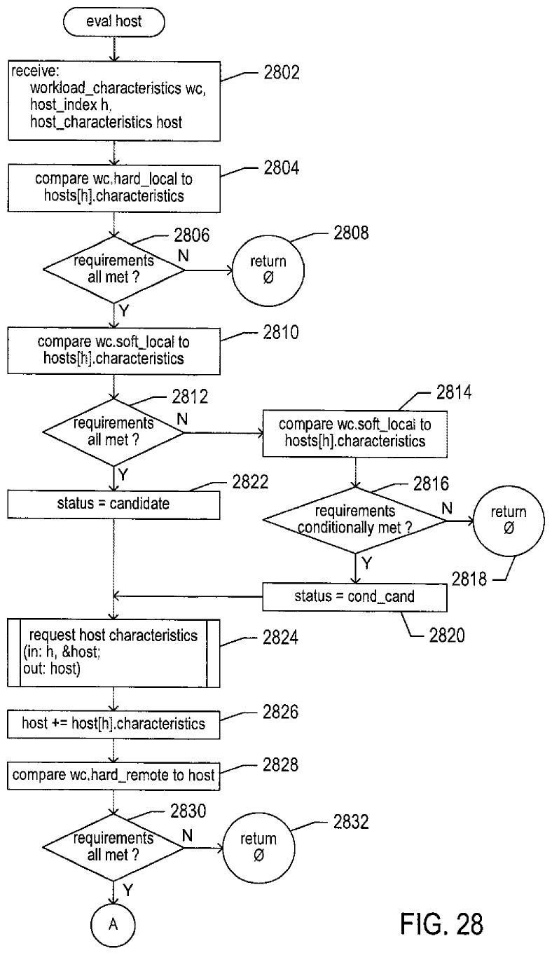

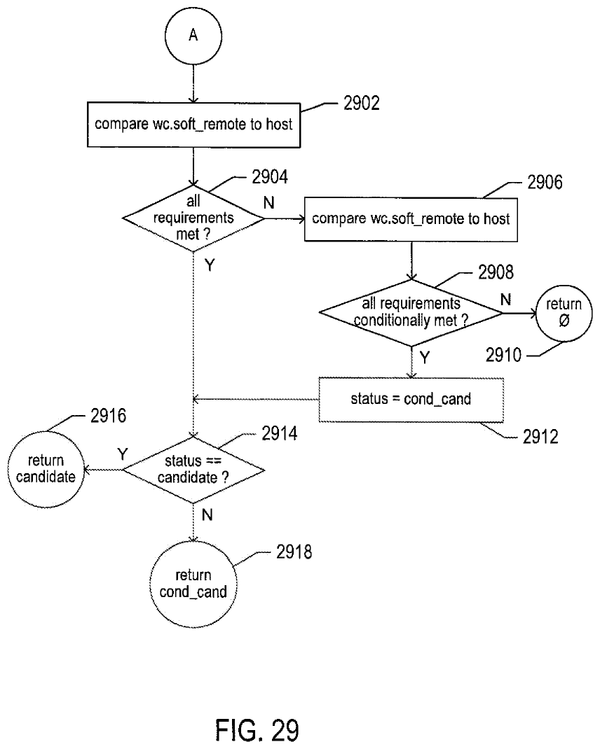

FIGS. 28-29 provide control-flow diagrams for the routine “eval host,” called in step 2605 of FIG. 26. In step 2802, the routine “eval host” receives a set of workload characteristics wc, a host index h, and a host_characteristics data structure host, which is received by reference. In step 2804, the routine “eval host” compares the hard, local requirements portion of the workload requirements contained in wc to the characteristics for the host indexed by the received host index h, where the hard, local requirements portion of the workload characteristics refers to the logical partition 2308 in FIG. 23. When all the requirements are not met, as determined in step 2806, the routine “eval host” returns a null value in step 2808. Otherwise, the routine “eval host” compares the soft, local requirements portion of the workload characteristics to the characteristics for the host indexed by the received host index h, in step 2810, where the soft, local requirements refer to the logical partition 2310 in FIG. 23. When all the requirements are not met, as determined in step 2812, the routine “eval host” again compares the soft, local requirements portion of the workload characteristics to the characteristics for the host indexed by the received host index h, in step 2814, to determine whether the requirements were conditionally met by the host indexed by the received host index h. When the requirements are not conditionally met, as determined in step 2816, the routine “eval host” returns a null value in step 2818. Otherwise, a local variable status is set to cond_cand, in step 2820. When all the soft requirements are met, as determined in step 2812, the local variable status is set to the value candidate, and step 2022. In step 2824, a routine “request host characteristics” is called in order to update the host_characteristics data structure host with host characteristics that must be requested from the host, such as current available processing bandwidth, current available memory, and other such characteristics. These types of host characteristics are dynamic, and cannot be locally stored for long periods of time. The non-dynamic and dynamic host characteristics are known to the routine “request host characteristics.” The locally available host characteristics for the indexed host are then added to the host_characteristics data structure host, in step 2826. In step 2828, the routine “eval host” compares the hard, remote workload or virtual machine requirements to the host characteristics stored in the host_characteristics data structure host, where the hard, remote workload and/or virtual machine requirements correspond to logical partition 2312 in FIG. 23. When all the requirements are not met, as determined in step 2830, the routine “eval host” returns a null value in step 2832. Otherwise, control flows to step 2902 in FIG. 29. In step 2902, the routine “eval host” compares the soft, remote requirements for the virtual machine or workload to the host characteristics stored in the host_characteristics data structure host, where the soft, remote workload or virtual-machine requirements correspond to logical partition 2314 in FIG. 23. When all the requirements are not met, as determined in step 2904, the routine “eval host” again, in step 2906, compares the soft, remote requirements for the virtual machine or workload to the host characteristics stored in the host_characteristics data structure host to determine whether or not all the requirements are at least conditionally met. When all the requirements are not at least conditionally met, as determined in step 2908, the routine “eval host” returns a null value in step 29. Otherwise the local variable status is set to cond_cand in step 2912. When the local variable status has the value candidate, as determined in step 2914, the routine “eval host” returns the value candidate in step 2916. Otherwise, the routine “eval host” returns the value cond_cand in step 2918.

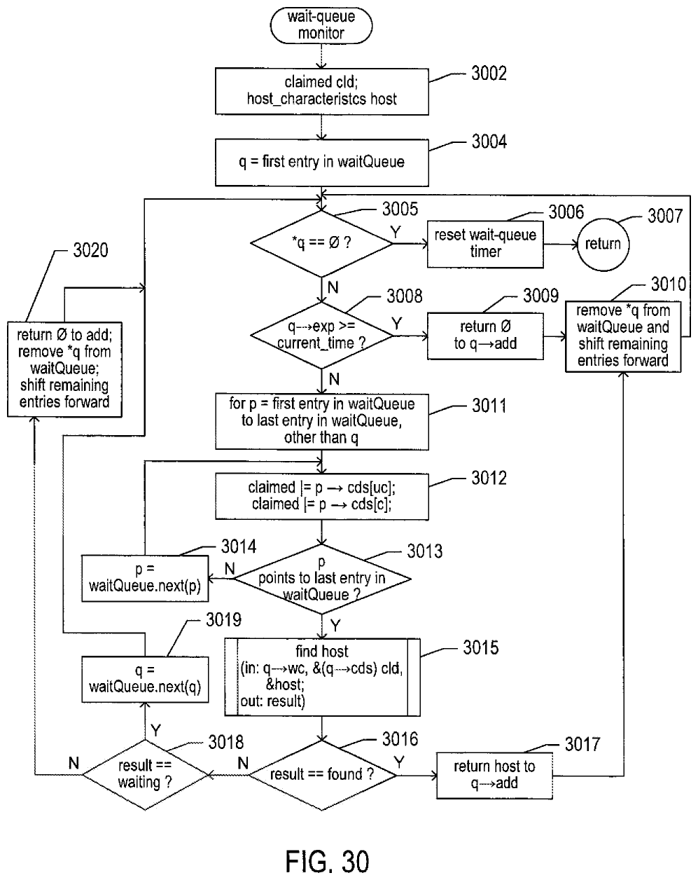

FIG. 30 provides a control-flow diagram for a routine “wait-queue monitor.” This routine is periodically awakened by expiration of a timer, or by other means, in order to attempt to find hosts for the workloads and/or virtual machines waiting for hosts on the wait queue. In step 3002, the routine “wait-queue monitor” declares a local claimed data structure cld and a local host_characteristics data structure host. In the loop of steps 3005-3020, the routine “wait-queue monitor” considers each entry on the wait queue. When the currently considered entry does not contain a valid work2place data structure, as determined in step 3005, there are no more wait-queue entries to consider, and the routine “wait-queue monitor” resets the wait-queue timer, in step 3006, and returns, in step 3007. Otherwise, when the currently considered wait-queue entry has expired, as determined in step 3008, a null value is asynchronously returned to the requester, in step 3009, and the currently considered wait-queue entry is removed from the wait queue in step 3010. Otherwise, in the inner for-loop of steps 3011-3014, the claimed data structure cld is initialized to indicate those hosts that have been claimed by workloads and/or virtual machines, other than the workload and/or virtual machine corresponding to the currently considered wait-queue entry, similar to the initialization of the claimed data structure in the, for-loop of steps 2506-2509 in FIG. 25. In step 3015, the previously discussed routine “find host” is called to find a host for the workload and/or virtual machine represented by the currently considered wait-queue entry. When the result returned by the routine “find host” is equal to found, as determined in 3016, the routine “wait-queue monitor” asynchronously returns the host data structure to the host-selection requester, in step 3017, with control then flowing to previously discussed step 3010. Otherwise, when the routine “find host” returns the value waiting, as determined in step 3018, control flows to step 3019, where the entry pointer q is advanced, and then back to step 3005 for a next iteration of the loop of steps 3005-3020. Otherwise, control flows to step 3020, where a null value is asynchronously returned to the host-selection requester and the currently considered wait-queue entry is removed from the wait queue.

The present invention has been described in terms of particular embodiments, it is not intended that the invention be limited to these embodiments. Modifications within the spirit of the invention will be apparent to those skilled in the art. Any of many different implementations of the currently disclosed deployment/configuration-policy evaluator can be obtained by varying various design and implementation parameters, including modular organization, control structures, data structures, hardware, operating system, and virtualization layers, automated orchestration systems, virtualization-aggregation systems, and other such design and implementation parameters. For example, host selections may involve more complex logic. Host-selection requests may, for example, be assigned priorities, with higher-priority host-selection requests processed the head of lower-priority host-selection requests. As mentioned above, the nature of the workload and/or virtual-machine characteristics and parameter values considered as hard and soft requirements for candidate hosts may vary with different implementations. In some implementations, only relatively high-level requirements may be considered, such as requirements for a certain type of hypervisor. In other implementations, many complex hosting requirements may be factored into the host-selection process, including detailed requirements related to the host instruction-set architecture, hardware components, and other characteristics and parameters.

1. A method for improving a management system that manages a homogeneous distributed computer system, the management system including a management-system server and homogeneous-management-system agents in each of a set of homogeneous host servers within the homogeneous distributed computer system, the improved management system managing a heterogeneous distributed computer system that includes non-homogeneous host servers, the method comprising:
implementing one or more heterogeneous-management-system agents for one or more types of non-homogeneous host servers, each heterogeneous-management-system agent providing an interface to the management-system server that is provided by the homogeneous-management-system agents but that each implements functionality accessed through the interface by the management server using functionalities and interfaces provided by a non-homogeneous host server in which the heterogeneous-management-system agent is incorporated; and
incorporating, into the improved management system, a host-selection function that selects a host server for placement of a workload and/or virtual machine into a host server selected from among homogeneous host servers and non-homogeneous host servers.

2. The method of claim 1 wherein a host server includes a hardware layer, an instruction-set-architecture layer, a virtualization layer, and a guest-operating-system layer.

3. The method of claim 2 wherein a first host server differs from a second host server when one or more characteristics or parameters values of the hardware layer of the first host server differs from one or more corresponding characteristics or parameters values of the hardware layer of the second host server, when one or more characteristics or parameters values of the instruction-set-architecture layer of the first host server differs from one or more corresponding characteristics or parameters values of the instruction-set-architecture layer of the second host server, when one or more characteristics or parameters values of the virtualization layer of the first host server differs from one or more corresponding characteristics or parameters values of the virtualization layer of the second host server, and when one or more characteristics or parameters values of the guest-operating-system layer of the first host server differs from one or more corresponding characteristics or parameters values of the guest-operating-system layer of the second host server.

4. The method of claim 3
wherein characteristics and parameters values of a hardware layer of a host server include
memory capacity,
number and types of processors,
processor instruction-execution bandwidth or bandwidths,
number and types of graphical processor units,
number and type of mass-storage devices, and
data-transfer bandwidths of internal buses and communications links;
wherein characteristics and parameters values of an instruction-set-architecture layer of a host server include
numbers and types of data-storage registers,
types of, arguments input to, and outputs from, instructions,
numbers and types of control registers,
numbers and types of registers that support virtual memory, and
type of security model;
wherein characteristics and parameters values of a virtualization-layer of a host server include
hypervisor type,
support for real-time guest operating systems,
support for static or binary instruction translation,
a set of supported operating systems,
a set of system requirements, and
a functional interface provided by the virtualization layer; and
wherein characteristics and parameters values of a guest-operating-system layer of a host server include
a set of system calls,
whether or not the guest operating system supports real-time executables,
a set of hypervisors that support the guest operating system,
whether or not the guest operating system is distributed,
whether or not the guest operating system provides virtual memory,
a maximum number of processes and threads supported by the guest operating system,
system requirements, and
file-system type.

5. The method of claim 1 wherein the host-selection function receives requirements associated with a workload and/or virtual machine and returns one of three results:
a first result comprising an indication of host server that is available in the heterogeneous distributed computer system to receive and launch execution of the workload and/or virtual machine:
a second result comprising an indication that there is no host server in the heterogeneous distributed computer system that can receive and launch execution of the workload and/or virtual machine; and
a third result comprising an indication that there is a host server in the heterogeneous distributed computer system that can receive and launch execution of the workload and/or virtual machine but that the workload and/or virtual machine has been queued to a wait queue to wait for an available host server.

6. The method of claim 5 wherein the received requirements associated with the workload and/or virtual machine include:
hard requirements that are compared to stored information to determine whether or not the hard requirements are met by a particular host server;
soft requirements that are compared to stored information to determine whether or not the soft requirements are met by a particular host server;
hard requirements that are compared to information requested of, and received from, a particular host server to determine whether or not the hard requirements are met by the particular host server; and
soft requirements that are compared to information requested of, and received from, a particular host server to determine whether or not the soft requirements are met by the particular host server.

7. The method of claim 6
wherein hard requirements require particular characteristics, parameter values, or parameter-value ranges of a candidate host server; and
wherein soft requirements can be satisfied by two or more alternative characteristics or alternative features.

8. The method of claim 7 wherein the host-selection function returns the first result
when all of the hard are satisfied by a candidate host server and all of the soft requirements can be satisfied by the candidate host without relying on alternative characteristics or features that deleteriously affect performance or efficiency of the workload and/or virtual machine; and
when all of the hard requirements are met by the candidate host server, all of the soft requirements are satisfied by the candidate host, with reliance on alternative characteristics or features for one or more soft requirements that deleteriously affect performance or efficiency of the workload and/or virtual machine only because no host server in the heterogeneous distributed computer system can satisfy the one or more soft requirements without deleteriously affecting performance or efficiency of the workload and/or virtual machine.

9. The method of claim 7 wherein the host-selection function returns the second result
when there is no host server in the heterogeneous distributed computer system that satisfies all of the hard and soft requirements;
when there will be no host server in the heterogeneous distributed computer system that satisfies all of the hard and soft requirements within a specified time interval; and
when the workload and/or virtual machine has waited for longer than the specified time interval for a host server.

10. The method of claim 7 wherein the host-selection function returns the third result
when there is a host server in the heterogeneous distributed computer system that satisfies all of the hard and soft requirements but there is no currently available host server in the heterogeneous distributed computer system that satisfies all of the hard and soft requirements and when a specified time interval is greater than a threshold value.

11. An improved management system that manages a heterogeneous distributed computer system that includes heterogeneous host servers interconnected by internal networks, the improved management system comprising:
a management-system server;
management-system agents incorporated in each of a set of heterogeneous host servers within the heterogeneous distributed computer system, each management-system agent providing a common interface to the management system but implementing functionality accessed through the interface by the management server using functionalities and interfaces specific to the host server in which the management-system agent is incorporated; and
a host-selection function that selects a host server for placement of a workload and/or virtual machine into a host server selected from among the heterogeneous host servers.

12. The improved management system of claim 11
wherein a host server includes a hardware layer, an instruction-set-architecture layer, a virtualization layer, and a guest-operating-system layer; and
wherein a first host server differs from, and is thus heterogeneous with respect to, a second host server when one or more characteristics or parameters values of the hardware layer of the first host server differs from one or more corresponding characteristics or parameters values of the hardware layer of the second host server, when one or more characteristics or parameters values of the instruction-set-architecture layer of the first host server differs from one or more corresponding characteristics or parameters values of the instruction-set-architecture layer of the second host server, when one or more characteristics or parameters values of the virtualization layer of the first host server differs from one or more corresponding characteristics or parameters values of the virtualization layer of the second host server, and when one or more characteristics or parameters values of the guest-operating-system layer of the first host server differs from one or more corresponding characteristics or parameters values of the guest-operating-system layer of the second host server.

13. The improved management system of claim 11
wherein characteristics and parameters values of a hardware layer of a host server include
memory capacity,
number and types of processors,
processor instruction-execution bandwidth or bandwidths,
number and types of graphical processor units,
number and type of mass-storage devices, and
data-transfer bandwidths of internal buses and communications links;
wherein characteristics and parameters values of an instruction-set-architecture layer of a host server include
numbers and types of data-storage registers,
types of, arguments input to, and outputs from, instructions,
numbers and types of control registers,
numbers and types of registers that support virtual memory, and
type of security model;
wherein characteristics and parameters values of a virtualization-layer of a host server include
hypervisor type,
support for real-time guest operating systems,
support for static or binary instruction translation,
a set of supported operating systems,
a set of system requirements, and
a functional interface provided by the virtualization layer; and
wherein characteristics and parameters values of a guest-operating-system layer of a host server include
a set of system calls,
whether or not the guest operating system supports real-time executables,
a set of hypervisors that support the guest operating system,
whether or not the guest operating system is distributed,
whether or not the guest operating system provides virtual memory,
a maximum number of processes and threads supported by the guest operating system,
system requirements, and
file-system type.

14. The improved management system of claim 11 wherein the host-selection function receives requirements associated with a workload and/or virtual machine and returns one of three results:
a first result comprising an indication of host server that is available in the heterogeneous distributed computer system to receive and launch execution of the workload and/or virtual machine;
a second result comprising an indication that there is no host server in the heterogeneous distributed computer system that can receive and launch execution of the workload and/or virtual machine; and
a third result comprising an indication that there is a host server in the heterogeneous distributed computer system that can receive and launch execution of the workload and/or virtual machine but that the workload and/or virtual machine has been queued to a wait queue to wait for an available host server.

15. The improved management system of claim 14 wherein the received requirements associated with the workload and/or virtual machine include:
hard requirements that are compared to stored information to determine whether or not the hard requirements are met by a particular host server;
soft requirements that are compared to stored information to determine whether or not the soft requirements are met by a particular host server:
hard requirements that are compared to information requested of, and received from, a particular host server to determine whether or not the hard requirements are met by the particular host server; and
soft requirements that are compared to information requested of, and received from, a particular host server to determine whether or not the soft requirements are met by the particular host server.

16. The improved management system of claim 15
wherein hard requirements require particular characteristics, parameter values, or parameter-value ranges of a candidate host server; and
wherein soft requirements can be satisfied by two or more alternative characteristics or alternative features.

17. The improved management system of claim 16 wherein the host-selection function returns the first result
when all of the hard are satisfied by a candidate host server and all of the soft requirements can be satisfied by the candidate host without relying on alternative characteristics or features that deleteriously affect performance or efficiency of the workload and/or virtual machine; and
when all of the hard requirements are met by the candidate host server, all of the soft requirements are satisfied by the candidate host, with reliance on alternative characteristics or features for one or more soft requirements that deleteriously affect performance or efficiency of the workload and/or virtual machine only because no host server in the heterogeneous distributed computer system can satisfy the one or more soft requirements without deleteriously affecting performance or efficiency of the workload and/or virtual machine.

18. The improved management system of claim 16 wherein the host-selection function returns the second result
when there is no host server in the heterogeneous distributed computer system that satisfies all of the hard and soft requirements;
when there will be no host server in the heterogeneous distributed computer system that satisfies all of the hard and soft requirements within a specified time interval; and
when the workload and/or virtual machine has waited for longer than the specified time interval for a host server.

19. The improved management system of claim 16 wherein the host-selection function returns the third result
when there is a host server in the heterogeneous distributed computer system that satisfies all of the hard and soft requirements but there is no currently available host server in the heterogeneous distributed computer system that satisfies all of the hard and soft requirements and when a specified time interval is greater than a threshold value.

20. A physical data-storage device that stores computer instructions that, when executed by an improved management system that manages a heterogeneous distributed computer system including heterogeneous host servers interconnected by internal networks, the improved management system comprising a management-system server, and management-system agents incorporated in each of a set of heterogeneous host servers within the heterogeneous distributed computer system, each management-system agent providing a common interface to the management system but implementing functionality accessed through the interface by the management server using functionalities and interfaces specific to the host server in which the management-system agent is incorporated, control the management system to select a host server for placement of a workload and/or virtual machine into a host server selected from among the heterogeneous host servers using a host-selection function that:
receives requirements associated with a workload and/or virtual machine; and
returns one of three results, including
a first result comprising an indication of host server that is available in the heterogeneous distributed computer system to receive and launch execution of the workload and/or virtual machine;
a second result comprising an indication that there is no host server in the heterogeneous distributed computer system that can receive and launch execution of the workload and/or virtual machine; and
a third result comprising an indication that there is a host server in the heterogeneous distributed computer system that can receive and launch execution of the workload and/or virtual machine but that the workload and/or virtual machine has been queued to a wait queue to wait for an available host server.
